(19) United States
(12) Patent Application Publication
(10) Pub. No.: US 2018/0032483 A1
(43) Pub. Date: Feb. 1, 2018

(54) INFORMATION PROCESSING DEVICE, CONTROL METHOD OF AN INFORMATION PROCESSING DEVICE, AND STORAGE MEDIUM

(71) Applicant: SEIKO EPSON CORPORATION, Tokyo (JP)

(72) Inventors: Hidehisa OMIYA, Matsumoto-shi (JP); Koji NISHIZAWA, Shiojiri-shi (JP); Muni I, Matsumoto-shi (JP); Ryota SHIMOSATO, Azumino-shi (JP)

(73) Assignee: SEIKO EPSON CORPORATION, Tokyo (JP)

(21) Appl. No.: 15/663,108

(22) Filed: Jul. 28, 2017

(30) Foreign Application Priority Data
Jul. 29, 2016 (JP) 2016-150737
Jul. 29, 2016 (JP) 2016-150738
Jul. 29, 2016 (JP) 2016-150739

(51) Int. Cl. G06F 17/21; G06F 17/27; G06F 3/0482

(52) U.S. Cl. CPC G06F 17/212; G06F 3/0482; G06F 17/271; G06F 3/147

(57) ABSTRACT

An information processing device includes a controller configured to: acquire text data of information printed on a print medium written as text; parse the text written in the acquired text data into words; display the words such that at least some of the words are selectable; and analyze the text data based on one or more selected words.

### CROSS-REFERENCE TO RELATED APPLICATIONS

This application claims priority under 35 U.S.C. §119 to Japanese Application No. 2016-150737, filed Jul. 29, 2016, Japanese Application No. 2016-150738, filed Jul. 29, 2016, and Japanese Application No. 2016-150739, filed Jul. 29, 2016, which are hereby incorporated by reference in their entireties.

### BACKGROUND

### 1. Technical Field

The present disclosure relates to an information processing device, a control method of an information processing device, and a storage medium.

### 2. Related Art

Technology for converting data output from the transaction processing unit of a POS terminal to a data format that can be understood by an external device, sending the converted data to the external device, and managing the transmitted data on the external device is described in JP-A-2012-27633, for example.

At a POS terminal that runs processes based on transactions such as the POS terminal described in JP-A-2012-27633, either the POS terminal or a printer connected to the POS terminal prints receipts based on the transactions. Various information, including information related to the transactions, is printed on the receipts.

Like the information printed on receipts, information printed on a print medium may also include valuable information that can be later used in other ways. As a result, an information processing device may analyze the text data that is printed as text in the information printed on the print medium. An issue when analyzing the data is simplifying as much as possible the operations that must be performed by the user, and thereby reduce the burden on the user.

### SUMMARY

Certain embodiments described herein are directed to this issue, and one objective of certain embodiments is to simplify the operations that must be performed by the user when analyzing text data by the information processing device.

An information processing device according to one embodiment includes a controller configured to acquire text data of information printed on a print medium written as text, parse the text written in the acquired text data into words, display the words selectably, and analyze the text data based on one or more selected words.

This configuration simplifies the tasks performed by the user to analyze text data using an information processing device.

In one aspect, text is arranged in the text data according to the layout in which information is printed on the print medium; and the controller displays the text parsed into words according to the layout.

This configuration enables the user to easily and directly know the content and layout of the text written in text data.

In another aspect, the controller applies a specific style to the displayed words that are candidates for selection.

This configuration enables to user to appropriately select desired words by knowing which words are candidates for selection.

In another aspect, when one word is selected, the controller enables selecting words that are consecutive to the one word and are on the same line as the one word.

When selecting multiple words, this configuration indicates which words that are consecutive and on the same line can be selected, thereby enabling the user to select words without mistake.

In another aspect, a printing device capable of printing receipts is connected to the information processing device; and the controller acquires as the text data information printed on the receipt by the printing device.

This configuration simplifies the tasks performed by the user to analyze text data corresponding to a receipt using an information processing device.

In another aspect, the controller parses text written in the text data into words based on space characters representing white space, and delimiter characters including a return character representing a new line.

This configuration enables the information processing device to accurately parse words using space characters and new line (carriage return) characters.

In another aspect, the text includes predefined special characters, and regular characters not including the delimiter characters and special characters; and the controller parses consecutive special characters not interrupted by a delimiter character, and consecutive regular characters not interrupted by a delimiter character, as one word.

This configuration enables the information processing device to accurately parse words.

Another embodiment is directed to a control method of an information processing device, the control method including steps of acquiring text data of information printed on a print medium written as text; parsing the text written in the acquired text data into words, and displaying the words selectably; and analyzing the text data based on one or more selected words.

This configuration simplifies the tasks performed by the user to analyze text data using an information processing device.

Another embodiment is directed to a control program that can be executed by a controller that controls an information processing device, the control program causing the controller to execute steps including: acquiring text data of information printed on a print medium written as text; parsing the text written in the acquired text data into words, and displaying the words selectably; and analyzing the text data based on one or more selected words.

This configuration simplifies the tasks performed by the user to analyze text data using an information processing device.

Other objects and embodiments will become apparent and appreciated by referring to the following description and claims taken in conjunction with the accompanying drawings.

### BRIEF DESCRIPTION OF THE DRAWINGS

FIG. 1 illustrates the configuration of a transaction processing system according to one embodiment.

FIG. 2 is a block diagram illustrating the functional configuration of devices in the transaction processing system.

FIG. 3 is a flow chart of tablet terminal, printing device, and control server operation.

FIG. 4 shows an example of print data.

FIG. 5A shows an example of a receipt.

FIG. 5B shows an example of a receipt.

FIG. 6A shows an example of printed text data.

FIG. 6B shows an example of printed text data.

FIG. 7 illustrates a record in a parser management database FIG. 8 is used to describe analyzed elements.

FIG. 9 shows an example of analytical data.

FIG. 10 illustrates a record in the analytical data management database.

FIG. 11A shows an example of a first user interface.

FIG. 11B shows an example of a second user interface.

FIG. 11C shows an example of a third user interface.

FIG. 12 illustrates a record in a printer management database.

FIG. 13 shows an example of a fourth user interface.

FIG. 14A is a table of words contained in the text data in the example in FIG. 6A.

FIG. 14B is a table of words contained in the text data in the example in FIG. 6B.

FIG. 15A illustrates a text display screen displaying text based on the printed text data in FIG. 6B.

FIG. 15B illustrates a text display screen displaying text based on the printed text data in FIG. 6B.

FIG. 16 shows an example of a fourth user interface.

FIG. 17 shows an example of a fourth user interface.

FIG. 18 shows an example of a fourth user interface.

FIG. 19 shows an example of a fourth user interface.

FIG. 20 shows an example of a fourth user interface.

FIG. 21 shows an example of a fourth user interface.

FIG. 22 shows an example of a fourth user interface.

FIG. 23 is a flow chart of control server operation.

FIG. 24 shows an example of a fourth user interface.

FIG. 25 shows an example of a fourth user interface.

FIG. 26 shows an example of a fourth user interface.

FIG. 27 shows an example of a fourth user interface.

FIG. 28 shows an example of a fourth user interface.

FIG. 29 shows an example of a fourth user interface.

FIG. 30 shows an example of a fourth user interface.

FIG. 31 shows an example of a fourth user interface.

FIG. 32 shows an example of a fourth user interface.

FIG. 33 shows an example of a fourth user interface.

FIG. 34 shows an example of a fourth user interface.

FIG. 35 shows an example of a fourth user interface.

### DETAILED DESCRIPTION

Embodiments of the invention are described below with reference to the accompanying figures.

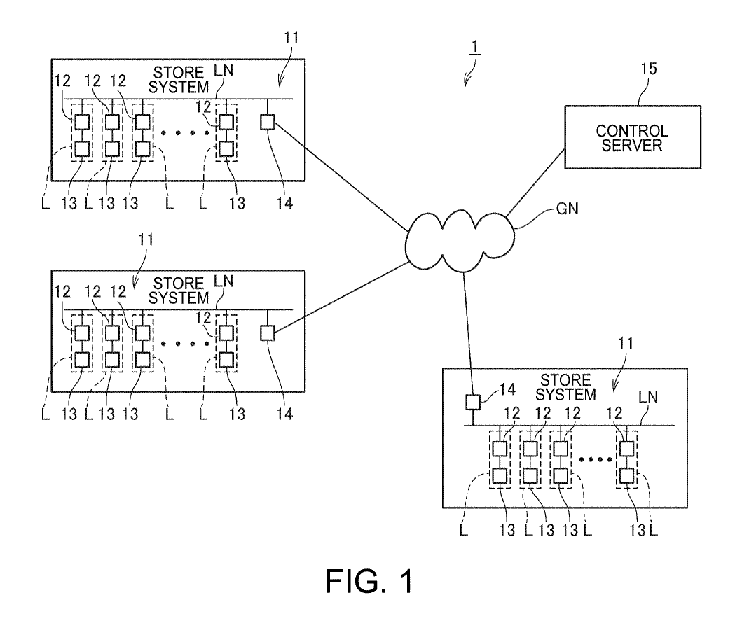

FIG. 1 shows the configuration of a transaction processing system 1 (information processing system) according to one embodiment of the invention.

As shown in FIG. 1, the transaction processing system 1 includes a plurality of store systems 11. A store system 11 is a system that is used in retail businesses such as supermarkets, convenience stores, department stores, and restaurants. The business may be any facility in which a product is provided and a customer transaction is performed according to the provision of the product. In this embodiment, the product is not limited to a physical product supplied to the customer, and means any product that is provided to a customer in exchange for payment, including services provided to customers and food or drink provided to customers.

The store system 11 has functions for processing transactions according to the products purchased by customers, and producing receipts based on the transactions.

A checkout counter L where customer transactions are processed is located in the business where the store system 11 is deployed. A printer 12 capable of recording on roll paper (print media) is installed at the checkout counter L. A tablet terminal 13 that connects to and communicates wirelessly with the printer 12 and controls the printer 12 is also disposed at the checkout counter L.

During a transaction at the checkout counter L, the cash register operator reads barcodes from the products or product packaging using a barcode reader BR connected to the printer 12, and inputs information related to the transaction to the tablet terminal 13. The printer 12 sends data based on reading with the barcode reader BR to the tablet terminal 13. Based on the data acquired by reading with the barcode reader BR and received from the printer 12, and transaction-related input from the operator, the tablet terminal 13 controls the printer 12 to produce a receipt. The receipt produced by the printer 12 is then given by the operator to the customer.

The configuration, functions, and processes based on the functions of the printer 12 and tablet terminal 13 are described further below.

A local area network LN is deployed in the store system 11.

The printer 12 connects to the local area network LN.

A communication device 14 is also connected to the local area network LN. The communication device 14 is an interface device that connects to the local area network LN and a global network GN including the Internet, telephone network, and other communication networks.

The communication device 14 has the functions of a modem (or ONU (Optical Network Unit)), a router, a NAT (Network Address Translation) device, and a DHCP (Dynamic Host Configuration Protocol) server. The communication device 14 transfers data that is sent and received between devices when a device connected to the local area network LN and a device connected to the global network GN communicate with each other. Note that the communication device 14 is represented by a single block in FIG. 1, but the communication device 14 may comprise plural devices with different functions.

The printer 12 can also access the global network GN through the communication device 14.

A control server 15 (information processing device) is connected to the global network GN.

The control server 15 is a server that communicates with the printer 12. More specifically, when triggered by a request from a client, for example, the control server 15 runs a specific process. The control server 15 sends data based on the result of the process to the client as needed. Note that the control server 15 is represented by a single block in FIG. 1, but this does not mean that the control server 15 is embodied by a single server device. For example, the control server 15 may comprise a plurality of server devices. More specifically, the control server 15 may be configured in any way enabling executing the processes described below.

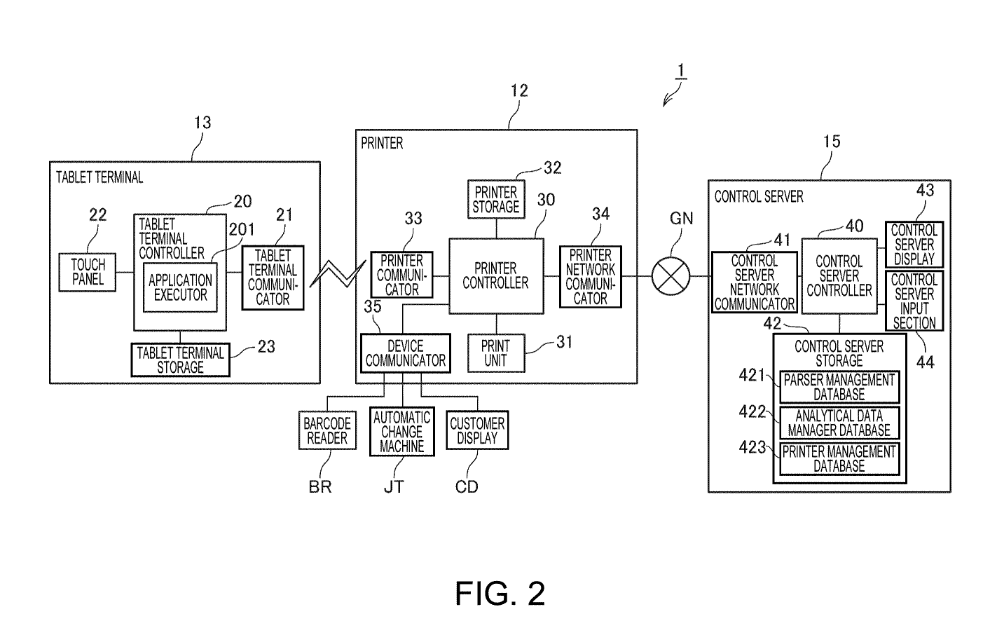

FIG. 2 is a block diagram illustrating the functional configuration of devices in the transaction processing system 1.

The tablet terminal 13 is a tablet (slate) computer with a touch panel 22 covering a large area on the front. When a transaction is processed at the checkout counter L, the tablet terminal 13 functions as a host computer that runs transaction-related processes and controls the printer 12.

As shown in FIG. 2, the tablet terminal 13 includes a tablet terminal controller 20, a tablet terminal communicator 21, a touch panel 22, and a tablet terminal storage 23.

The tablet terminal controller 20 comprises a CPU, ROM, RAM, ASIC, and other signal processing circuits not shown, and controls other parts of the tablet terminal 13. The tablet terminal controller 20 executes processes by the cooperation of hardware and software, such as a CPU reading a program stored in ROM to RAM and running the program from RAM, or by functions of the ASIC, or by a signal processing circuit executing processes by processing signals. A specific application is preinstalled to the tablet terminal 13. The tablet terminal controller 20 functions as an application executor 201 by reading and running the specific application, programs (such as the OS, APIs, plugins) associated with the specific application, or other programs.

The tablet terminal communicator 21 communicates with the printer 12 according to a specific communication protocol as controlled by the tablet terminal controller 20. The wireless communication standard for wireless communication between the tablet terminal 13 and printer 12 may be a wireless LAN standard compatible with an ad hoc mode, a wireless LAN standard compatible with an infrastructure mode, or a near-field communication standard such as Bluetooth (R), for example.

The touch panel 22 combines an LCD panel or other type of display panel, and a touch sensor overlaid to the display panel. The display panel displays images as controlled by the tablet terminal controller 20. The touch sensor detects touch operations by the user and outputs to the tablet terminal controller 20. The tablet terminal controller 20 then executes processes appropriate to the touch operation based on input from the touch sensor.

The tablet terminal storage 23 has nonvolatile memory, and stores data.

The printer 12 is a thermal printer that holds roll paper and forms dots on the stored roll paper with a line thermal head to print images.

The printing method of the printer 12 in this embodiment is thermal, but the printing method of the printer 12 is not limited to thermal printing, and may be inkjet or other method. The printhead of the printer 12 is also not limited to a line head, and may be a serial printhead.

As shown in FIG. 2, the printer 12 has a printer controller 30, print unit 31, printer storage 32, printer communicator 33, printer network communicator 34, and device communicator 35.

The printer controller 30 comprises a CPU, ROM, RAM, ASIC, and other signal processing circuits not shown, and controls other parts of the printer 12. The printer controller 30 executes processes by the cooperation of hardware and software, such as a CPU reading a program stored in ROM to RAM and running the program from RAM, or by functions of the ASIC, or by a signal processing circuit executing processes by processing signals.

The print unit 31 includes mechanisms related to printing on roll paper, such as a conveyance mechanism for conveying roll paper stored inside the cabinet of the printer 12, a printing mechanism for forming dots and printing images on the roll paper with a thermal head, and a cutter mechanism for cutting the roll paper at a specific position. As controlled by the printer controller 30, the print unit 31 conveys the roll paper with the conveyance mechanism, prints receipt-related images on the roll paper by the printing mechanism while, and then cuts the roll paper at a specific position with the cutter mechanism, producing a receipt.

The printer storage 32 has nonvolatile memory, and stores data.

The printer communicator 33 communicates with the tablet terminal 13 according to a specific communication protocol as controlled by the printer controller 30. Any desired wireless communication standard may be used for communication between the tablet terminal 13 and printer 12, including ad hoc mode wireless LAN standards, infrastructure mode wireless LAN standards, Bluetooth, or other near-field communication standard.

The printer network communicator 34 communicates with devices connected to the global network GN (including the control server 15) according to a specific communication protocol as controlled by the printer controller 30. The communication standard used for communication by the printer network communicator 34 may be HTTP, Web Socket, or other standard.

The device communicator 35 includes an interface board with ports such as a USB port, a serial communication port (such as RS-232C) other than a USB port, a port compatible with a parallel communication standard (such as IEEE 1284), a wired LAN standard port (such as Ethernet(R)), or other type of port. A device can connect to each port. The device communicator 35 communicates with the devices connected to the printer 12 through the ports as controlled by the printer controller 30.

Note that the device communicator 35 may be configured with a wireless communication capability for communicating wirelessly with devices.

A barcode reader BR, customer display CD, and an automatic change machine JT are examples of devices that connect to the tablet terminal 13 in this example.

The barcode reader BR is used to read barcodes from products and product packaging, and outputs the read result to the device communicator 35. The device communicator 35 outputs the data input from the barcode reader BR to the printer controller 30.

The customer display CD displays transaction-related information as controlled by the printer controller 30. The information presented on the customer display CD can be checked by the customer involved in the transaction at the checkout counter L.

The automatic change machine JT has cash receiver openings for receiving cash inserted by the customer and cash dispenser openings for dispensing change according to the amount received, and when cash is input through the cash receiver, the change due is dispensed from the cash return openings as controlled by the printer controller 30.

The control server 15 is a server device.

As shown in FIG. 2, the control server 15 includes a control server controller 40 (control unit), control server network communicator 41, control server storage 42, control server display 43, and control server input section 44.

The control server controller 40 comprises a CPU, ROM, RAM, ASIC, and other signal processing circuits not shown, and controls other parts of the control server 15. The control server controller 40 executes processes by the cooperation of hardware and software, such as a CPU reading a program stored in ROM to RAM and running the program from RAM, or by functions of the ASIC, or by a signal processing circuit executing processes by processing signals.

The control server network communicator 41 communicates with devices connected to the global network GN (including printers 12) according to a specific communication protocol as controlled by the control server controller 40. The communication standard used for communication by the control server network communicator 41 may be HTTP, Web Socket, or other standard.

The control server storage 42 has nonvolatile memory and stores data. In this example, the control server storage 42 stores a parser management database 421, analytical data manager database 422, and printer management database 423. The databases are described further below.

The control server display 43 includes a display panel, and displays information on the display panel as controlled by the control server controller 40.

The control server input section 44 includes a keyboard, mouse, or other type of input device, detects input to the input devices, and outputs to the control server controller 40. Based on input from the control server input section 44, the control server controller 40 runs processes based on the input to the input device.

Operation of the tablet terminal 13, printer 12, and control server 15 when a customer transaction is processed at the checkout counter L is described next.

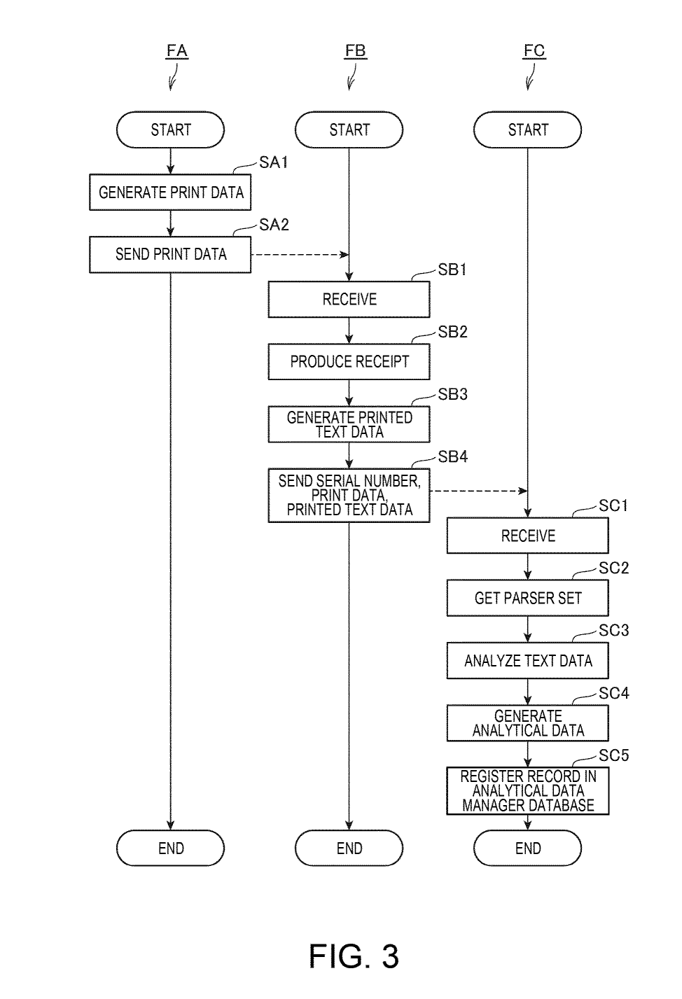

FIG. 3 is a flow chart of the operation of the tablet terminal 13, printer 12, and control server 15 when processing a transaction at the checkout counter L. Column FA describes the process of the tablet terminal 13, column FB describes the process of the printer 12, and column FC describes the process of the control server 15.

As shown in column FA of FIG. 3, the application executor 201 of the tablet terminal controller 20 of the tablet terminal 13 executes a transaction process (payment process) appropriately to the customer transaction, and generates print data based on the transaction process (step SA1).

More specifically, in step SA1, the application executor 201 displays a user interface enabling transaction input on the touch panel 22. The application executor 201 generates receipt information according to the operator input to the touch panel 22 and input from the printer 12 in conjunction with the customer transaction. The receipt information is information printed on the receipt produced by the printer 12. The specific content of the receipt information is described below using examples.

Next, the application executor 201 generates print data based on the generated receipt information. The print data is data instructing producing a receipt with the receipt information printed in a specific layout. The print data includes plural control commands in the command language of the printer 12.

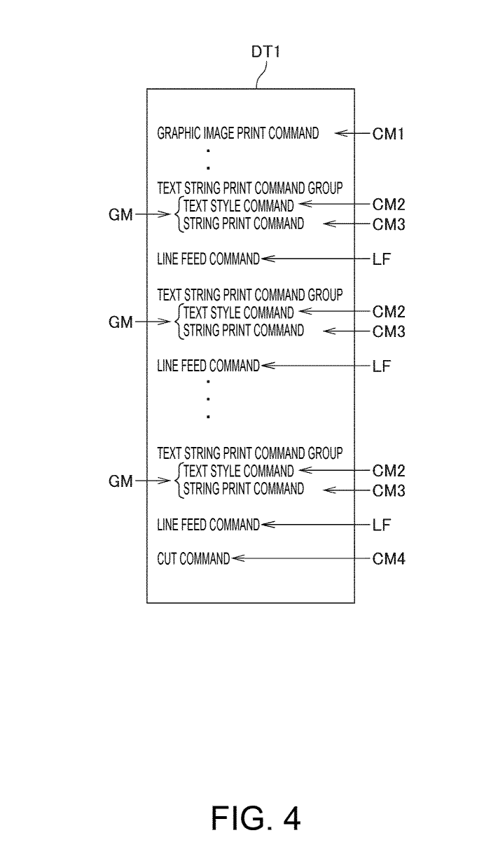

FIG. 4 shows print data DT1 as an example of print data.

As shown in the print data DT1 in FIG. 4, the print data may include a graphic image print command CM1, text string print command group GM, line feed command LF, and cut command CM4. The text string print command group GM includes a text style command CM2, and string print command CM3.

The graphic image print command CM1 is a control command including a specific command code and bitmapped or other type of image data, and instructs printing a graphic image based on the image data.

The image data is data storing information related to the color of each dot in a dot matrix arrangement.

A graphic image is an image printed based on image data received from a device functioning as a host computer (the tablet terminal 13 in this example), and is not an image printed based on font data. The logo information J1 described below is an example of a graphic image.

The string print command CM3 contained in the text string print command group GM is a control command instructing printing one line of text. The string print command CM3 includes a specific command code and information indicating the text string to print (a combination of one or more character codes comprising the string).

The text style command CM2 contained in the text string print command group GM is a control command specifying the styles to apply to the string to be printed by the string print command CM3. Styles that may be applied to the string may include right alignment, center alignment, left alignment, bold, underlining, adding emphasis marks, black/white inversion, rotation, enlargement, and reduction.

The printer storage 32 of the printer 12 stores font data for each printable character. The printer controller 30 of the printer 12 executes the following process to print a string based on one text string print command group GM.

The printer controller 30 converts each character code contained in the string print command CM3 in the one text string print command group GM to the corresponding font data. Next, the printer controller 30 applies any styling specified by the text style command CM2 in the same text string print command group GM to the font data for each character, and renders the font data in an image buffer. Next, the printer controller 30 controls the print unit 31 based on the font data rendered in the image buffer to print the string for one line.

The line feed command LF is a command specifying a line feed (new line) command.

The cut command CM4 is a command specifying cutting the roll paper.

As shown in column FA in FIG. 3, after generating the print data in step SA1, the application executor 201 controls the tablet terminal communicator 21 to send the generated print data to the printer 12 (step SA2).

As shown in column FB in FIG. 3, the printer controller 30 of the printer 12 controls the printer communicator 33 to receive the print data (step SB1).

Next, the printer controller 30 controls the print unit 31 to produce a receipt based on the print data received in step SB1 (step SB2). The resulting receipt is given to the customer.

A receipt printed by the printer 12 in the store has the following characteristics. Specifically, the layout of receipts produced by one printer 12 is the same unless there has been a change in a specific application installed on the tablet terminal 13. The layout of the printed receipts may also differ from one printer 12 to another printer 12 due to differences in the tablet terminals 13 that communicate with the printers 12.

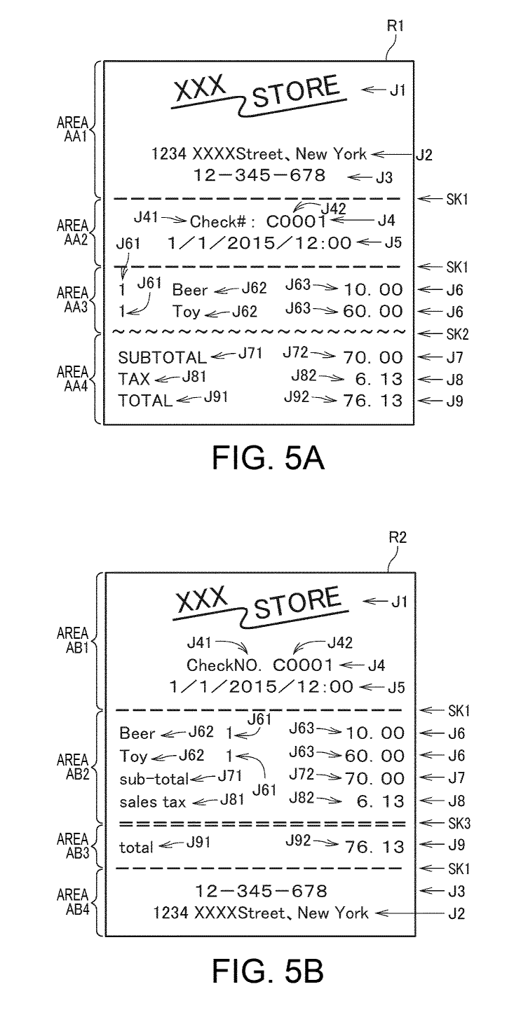

FIG. 5A shows receipt R1 as an example of a receipt produced by a printer 12 based on the print data. FIG. 5B shows a receipt R2 as an example of a receipt with a layout different from the layout of the receipt R1 shown in the example in FIG. 5A.

Note that the content of the information printed on the receipt R1 in FIG. 5A, and the content of the information printed on the receipt R1 in FIG. 5B, are the same.

Note that the object to which a character code is assigned in this example is referred to herein as a “character.” A character therefore includes symbols (such as @, $, ¥) to which a character code is assigned; and white space characters (also referred to as spaces or blanks) to which a character code is assigned. White space characters may be represented below by the character □□

Logo information J1 as a graphical representation of the name of the store is printed at the top of the receipt R1 in FIG. 5A. The logo information J1 is printed based on the graphic image print command CM1 described above.

Store address information J2 expressing the address of the store with a text string is recorded below the logo information J1 on the receipt R1. The store address information J2 is printed based on a text string print command group GM including a text style command CM2 specifying a center alignment style, and a string print command CM3 instructing printing a string expressing the store address.

Telephone number information J3, which is a text string representing the telephone number of the store, is printed on the line below the store address information J2. The telephone number information J3 is printed based on a text string print command group GM including a text style command CM2 specifying a center alignment style, and a string print command CM3 instructing printing a string expressing the telephone number of the business.

On the line following the telephone number information J3 in the receipt R1 is printed first area break information SK1. The first area break information SK1 is a string of multiple hyphens (−) on the same line.

The print area of the receipt R1 is divided by the first first area break information SK1, and the first area break information SK1 separates the area thereabove from the following content. Below, the area above the first area break information SK1 in receipt R1 is referred to as area AA1.

On the line following the first area break information SK1 on the receipt R1 is printed receipt identification related information J4. The receipt identification related information J4 contains a receipt identifier J42, which is a text string identifying the receipt. The value of the receipt identifier J42 is different on every receipt. The receipt identification related information J4 contains a receipt identification identifier J41, which is printed at the left side on the same line as the receipt identifier J42, and which is information indicating that the receipt identifier J42 is information identifying the receipt. In the example in FIG. 5A, the receipt identification identifier J41 of the receipt R1 is the string Check#.

The receipt identification related information J4 is printed based on a text string print command group GM including a text style command CM2 specifying a center alignment style, and the string print command CM3 described below. This string print command CM3 is a control command instructing printing the string expressing the receipt identification identifier J41, one space character, and a string expressing the receipt identifier J42. In the receipt R1 in FIG. 5A, the string expressing the receipt identification identifier J41, space character, and string expressing the receipt identifier J42 is the string Check#:□C0001.

On the line following the receipt identification related information J4 in the receipt R1 is printed a time stamp J5, which is a text string expressing the date and time the receipt was printed. The time stamp J5 is printed based on a text string print command group GM including a text style command CM2 specifying a center alignment style, and a string print command CM3 instructing printing a string expressing the date and time the receipt was printed.

First area break information SK1 is then printed below the time stamp J5.

The first and second instances of the first area break information SK1 on the receipt R1 define another print area in which specific information is printed. The area of the receipt R1 between the first and second instances of the first area break information SK1 is referred to below as area AA2.

Starting from the line following the second instance of first area break information SK1 in the receipt R1 is printed one or more lines of product information J6 (two lines shown in the example in FIG. 5A). The product information J6 is printed on the receipt R1 for each type of product purchased by the customer. Therefore, if the customer purchased three different products, three lines of product information J6 are printed, one for each product type. When multiple lines of product information J6 are printed on a receipt R1, the multiple lines of product information J6 are consecutively printed to different lines.

The product information J6 includes purchased quantity information J61, product name information J62, and price information J63. The purchased quantity information J61, product name information J62, and price information J63 are printed on the same line. The purchased quantity information J61 is a text string expressing the quantity (count) of the product purchased. The product name information J62 is a text string expressing the name of the corresponding product. The price information J63 is a text string expressing the price of the corresponding product.

The purchased quantity information J61, product name information J62, price information J63 are printed in this order on one line of the receipt R1 from left to right.

The product information J6 is printed based on a text string print command group GM including a text style command CM2 specifying a left alignment style, and the following string print command CM3.

This string print command CM3 is a control command instructing consecutively printing a string expressing the purchased quantity information J61, a white space character, a string expressing the product name information J62, one or more white space characters, and a string expressing the price information J63. The number of white space characters inserted between the product name information J62 string and the price information J63 string is adjusted so that the price information J63 is printed at the end of the line. The string expressing the purchased quantity information J61, white space character, string expressing the product name information J62, one or more white space characters, and string expressing the price information J63 that are consecutively printed for the product information J6 on the first (top) line of the product information J6 printed on the receipt R1 in FIG. 5A is the string 1□Beer□□ . . . □□10.00.

On the line following the last line of printed product information J6 on the receipt R1 is second area break information SK2. The second area break information SK2 is a string of multiple tilde (˜) characters printed consecutively on one line.

The print area of the receipt R1 is segmented by the second instance of first area break information SK1 and the first instance of second area break information SK2, and the area between the second instance of first area break information SK1 and the first instance of second area break information SK2 is referred to below as area AA3.

Subtotal related information J7 is printed on the receipt R1 on the line following the first instance of second area break information SK2. The subtotal related information J7 contains subtotal information J72. The subtotal related information J7 also contains a subtotal identifier J71, which is a text string printed to the left on the same line as the subtotal information J72, and indicates that the subtotal information J72 contains information indicating the transaction subtotal.

As shown in FIG. 5A, the subtotal identifier J71 in receipt R1 is an eight character string of the capital letters SUBTOTAL.

The subtotal related information J7 is printed based on a text string print command group GM including a text style command CM2 specifying a left alignment style, and the string print command CM3 described below. This string print command CM3 is a control command instructing consecutively printing a text string expressing the subtotal identifier J71, one or more white space characters, and a string expressing the subtotal information J72. The number of white space characters inserted between the subtotal identifier J71 string and the subtotal information J72 string is adjusted so that the subtotal information J72 is printed at the end of the line. In receipt R1 shown in FIG. 5A, the subtotal identifier J71 string, one or more white space characters, and string expressing the subtotal information J72 are printed consecutively as the string SUBTOTAL □□ . . . □□70.00.

On the line following the subtotal related information J7 of the receipt R1 is printed tax related information J8. The tax related information J8 includes tax information J82, which is a text string expressing the amount of tax. The tax related information J8 also contains a tax information identifier J81, which is a text string printed on the left on the same line as the tax information J82 and indicates that the tax information J82 contains the amount of tax.

As shown in FIG. 5A, the tax information identifier J81 of the receipt R1 is a string containing the three capital letters TAX.

The tax related information J8 is printed based on a text string print command group GM including a text style command CM2 specifying a left alignment style, and the string print command CM3 described below. This string print command CM3 is a control command instructing consecutively printing a text string expressing the tax information identifier J81, one or more white space characters, and a text string expressing the tax information J82. The number of white space characters inserted between the tax information identifier J81 string and the tax information J82 string is adjusted so the tax information J82 is printed at the end of the line. In the receipt R1 shown in FIG. 5A, the tax information identifier J81 string, one or more white space characters, and tax information J82 string is the string TAX□□ . . . □□6.13.

Transaction total related information J9 is printed on the line following the tax related information J8 on the receipt R1. The transaction total related information J9 contains transaction total information J92, which is a text string indicating the transaction total. The transaction total related information J9 also contains a transaction total identifier J91, which is a text string printed on the left on the same line as the transaction total information J92 and indicates that the transaction total information J92 contains the transaction total.

As shown in FIG. 5A, the transaction total identifier J91 of the receipt R1 is a string containing the five capital letters TOTAL.

The transaction total related information J9 is printed based on a text string print command group GM including a text style command CM2 specifying a left alignment style, and the following string print command CM3. This string print command CM3 is a control command instructing consecutively printing the transaction total identifier J91 string, one or more white space characters, and a text string expressing the transaction total information J92. The number of white space characters inserted between the transaction total identifier J91 string and the transaction total information J92 string is adjusted so the transaction total information J92 is printed at the end of the line. In the receipt R1 shown in FIG. 5A, the transaction total identifier J91 string, one or more white space characters, and transaction total information J92 string is the string TOTAL □□ . . . □□76.13.

When not differentiated, first area break information SK1, second area break information SK2, and third area break information SK3 described below are referred to as simply area break information.

Information is thus printed on receipt R1 using the following layout. That is, three instances of area break information are printed in the print area of the receipt R1, and the print area of the receipt is divided from the top by these three instances of area break information into four different areas referred to as area AA1, area AA2, area AA3, area AA4.

In area AA1 are sequentially printed the logo information J1, store address information J2, and store telephone number related information J3.

In area AA2 are sequentially printed the receipt identification related information J4 and time stamp J5.

In area AA3 is printed one or more lines of product information J6. The purchased quantity information J61, product name information J62, price information J63 contained in the product information J6 are printed sequentially on one line from left to right.

In area AA4 are sequentially printed the subtotal related information J7, tax related information J8, and transaction total related information J9.

As described above, regardless of the products purchased by the customer, each receipt R1 produced by the printer 12 is printed using the same layout as receipt R1 described above.

The receipt R2 shown in the example in FIG. 5B also starts with logo information J1 at the top.

Below the logo information J1 on the receipt R2 is printed receipt identification related information J4. The receipt identification related information J4 contains a receipt identification identifier J41 and receipt identifier J42.

As shown in FIG. 5B, the receipt identification identifier J41 of the receipt R2 is information starting with the string CheckNO. This string is different from the string printed as the receipt identification identifier J41 on receipt R1.

In receipt R2 the receipt identification related information J4 is printed centered. One white space character is inserted between the receipt identification identifier J41 and receipt identifier J42 in this receipt R2.

On the line following the receipt identification related information J4 in the receipt R2 is printed a time stamp J5. This time stamp J5 is also centered.

First area break information SK1 is then printed on the line following the time stamp J5 in receipt R2.

The receipt R2 is segmented by the first area break information SK1 into areas above and below the area break information SK1. The area of the receipt R2 above this first area break information SK1 is referred to below as area AB1.

Starting from the line following the area break information SK1 in the receipt R2 is printed consecutively on different lines one or more lines of product information J6 (two lines shown in FIG. 5B).

The purchased quantity information J61, product name information J62, price information J63 contained in the product information J6 are printed sequentially on one line of the receipt R2 from left to right.

In receipt R2, the product information J6 is printed based on a text string print command group GM including a text style command CM2 specifying a left alignment style, and the following string print command CM3.

This string print command CM3 is a control command instructing consecutively printing a string expressing the product name information J62, one or more white space characters, a string expressing the purchased quantity information J61, one or more white space characters, and a string expressing the price information J63. The number of white space characters inserted between the product name information J62 string and the purchased quantity information J61 string is adjusted so that the purchased quantity information J61 is printed at a specific position on the line. The number of white space characters inserted between the purchased quantity information J61 string and the price information J63 string is adjusted so that the price information J63 is printed at the end of the line. The string expressing the product name information J62, one or more white space characters, purchased quantity information J61 string, one or more white space characters, and a string expressing the price information J63 that are consecutively printed as the product information J6 on the first (top) line of the product information J6 printed on the receipt R2 in FIG. 5B is the string Beer □□ . . . ≡□1□□ . . . □□10.00.

Subtotal related information J7 is printed on the receipt R2 on the line following the last line of product information J6.

As shown in FIG. 5B, the subtotal identifier J71 of receipt R2 is an eight character string of the lowercase letters “sub-total”, and thus differs from the subtotal identifier J71 printed on receipt R1.

In receipt R2, the subtotal related information J7 is printed based on a text string print command group GM including a text style command CM2 specifying a left alignment style, and the string print command CM3 described below.

This string print command CM3 is a control command instructing consecutively printing including a text string expressing the subtotal identifier J71, one or more white space characters, and a string expressing the subtotal information J72. The number of white space characters inserted between the subtotal identifier J71 string and the subtotal information J72 string is adjusted so that the subtotal information J72 is printed at the end of the line. In receipt R1 shown in FIG. 5A, the subtotal identifier J71 string, one or more white space characters, and string expressing the subtotal information J72 are printed consecutively as the string sub-total □□ . . . □□70.00.

On the line following the subtotal related information J7 of the receipt R2 is printed tax related information J8. As shown in FIG. 5B, the tax information identifier J81 on receipt R2 is a text string including the five-character lowercase string “sales”, one white space character, and a three-character lowercase string “tax,” forming the string sales□tax, and is different from the tax information identifier J81 string on receipt R1 described above.

The tax related information J8 in receipt R2 is printed based on a text string print command group GM including a text style command CM2 specifying a left alignment style, and the string print command CM3 described below.

This string print command CM3 is a control command instructing consecutively printing a text string expressing the tax information identifier J81, one or more white space characters, and a text string expressing the tax information J82. The number of white space characters inserted between the tax information identifier J81 string and the tax information J82 string is adjusted so the tax information J82 is printed at the end of the line. In the receipt R2 shown in FIG. 5B, the tax information identifier J81 string, one or more white space characters, and tax information J82 string is the string sales □tax □□ . . . □□6.13.

On receipt R2, third area break information SK3 is printed on the line following the tax related information J8. The third area break information SK3 is a string of multiple equal signs (=) printed consecutively on one line.

The print area of receipt R2 is segmented by the first instance of first area break information SK1 and the first third area break information SK3 into different areas, and the area between the first area break information SK1 and the third area break information SK3 is referred to below as area AB2.

On receipt R2, the transaction total related information J9 is printed on the line following the third area break information SK3. As shown in FIG. 5B, the transaction total identifier J91 of the receipt R2 is a string containing the five lowercase letters “total”, and thus differs from the transaction total identifier J91 printed on receipt R1.

The transaction total related information J9 on receipt R2 is printed based on a text string print command group GM including a text style command CM2 specifying a left alignment style, and the following string print command CM3.

This string print command CM3 is a control command instructing consecutively printing the transaction total identifier J91 string, one or more white space characters, and a text string expressing the transaction total information J92. The number of white space characters inserted between the transaction total identifier J91 string and the transaction total information J92 string is adjusted so the transaction total information J92 is printed at the end of the line. In the receipt R2 shown in FIG. 5B, the transaction total identifier J91 string, one or more white space characters, and transaction total information J92 string is the string total □□ . . . □□76.13.

A second instance of area break information SK1 is printed on the receipt R2 on the line following the transaction total related information J9.

The print area of the receipt R2 is segmented by the first instance of third area break information SK3 and the second instance of first area break information SK1, and the area between this third area break information SK3 and the first area break information SK1 on the receipt R2 is referred to below as area AB3. The area below the second instance of first area break information SK1 is referred to below as area AB4.

On receipt R2, the telephone number information J3 is printed below the second instance of first area break information SK1. The telephone number information J3 is printed with centered alignment.

The store address information J2 is printed on the line below the telephone number information J3 on receipt R2. The store address information J2 is printed with centered alignment.

Information is thus printed in the layout described below on receipt R2. Specifically, three instances of area break information are printed in the print area of the receipt R2, and these three instances of area break information divide the print area from the top into four areas, area AB2, area AB2, area AB3, and area AB4.

In area AB1 are sequentially printed logo information J1, receipt identification related information J4, and a time stamp J5.

In area AB2 are sequentially printed one or more lines of product information J6, subtotal related information J7, and tax related information J8.

In area AB3 is printed the transaction total related information J9.

In area AB4 are sequentially printed additional information J10, telephone number information J3, and store address information J2.

As described above, regardless of the products purchased by the customer, each receipt R2 produced by the printer 12 is printed using the same layout as receipt R2 described above.

As will be obvious by comparing FIG. 5A and FIG. 5B, the layouts of receipt R1 and receipt R2 differ.

The information printed on the receipts is an example of receipt information. As shown by the examples of receipt R1 in FIG. 5A and FIG. 2 in FIG. 5B, the receipt information is printed according to a specific layout.

As shown in FIG. 3 column FB, after producing a receipt in step SB2, the printer controller 30 generates printed text data (text data) based on the print data (step SB3). The process of step SB3 is described below.

The printed text data is text data containing the text (character codes) of the information that is printed as text (characters) in the information that is printed on roll paper based on the print data.

In step SB3, the printer controller 30 extracts from the print data the control commands related to printing the strings, specifically the string print commands CM3 and line feed commands LF. Next, based on the extracted control commands, the printer controller 30 generates printed text data containing the information printed as characters on the receipt as text.

The printer controller 30 writes the information in the printed text data in a format reflecting the line feeds that are executed when printing. The printer controller 30 writes the information in the printed text data in a format not reflecting the styles specified by the text style commands CM2. As a result, when centered, left, or right alignment is specified as the styling to apply to a string by a text style command CM2, that styling is not reflected when writing the text in the printed text data.

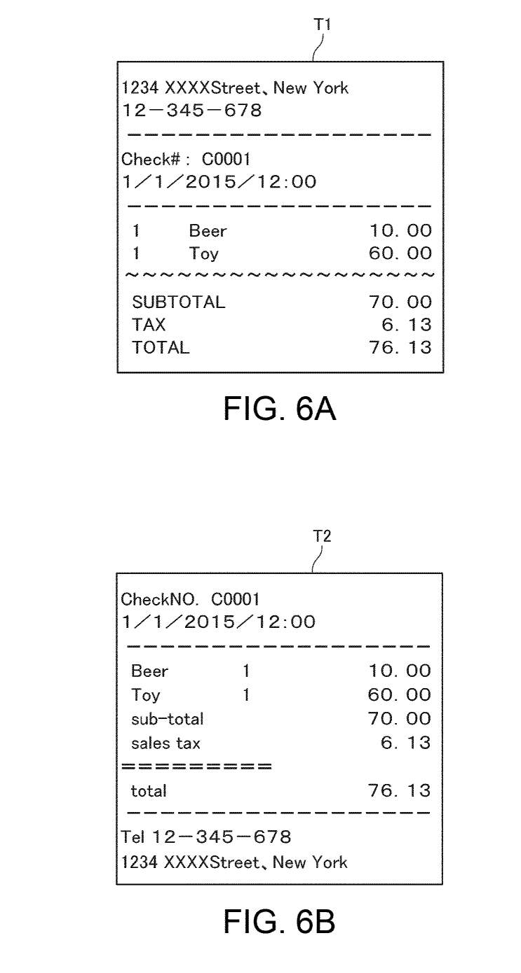

FIG. 6A shows an example of the content of printed text data T1, which is the text data that is generated based on the print data related to the receipt R1 shown in FIG. 5A. As will be obvious from comparing FIG. 6A and FIG. 5A, the information printed as text in receipt R1 is written in the printed text data T1 in the same printed order and reflecting the locations of the carriage returns in the printed receipt R1.

FIG. 6B shows an example of the content of printed text data T2 that is generated based on the print data for the receipt R2 shown in FIG. 5B. As will be obvious from comparing FIG. 6B and FIG. 5B, the information printed as text in receipt R2 is written in the printed text data T2 in the same printed order and reflecting the locations of the carriage returns in the printed receipt R2.

Note that because the logo information J1 is a graphic image, it is not written in the printed text data. More specifically, information other than the information printed based on font data corresponding to character codes is not recorded in the printed text data.

Next, as shown in FIG. 3 column FB, after generating the printed text data in step SB3, the printer controller 30 sends a serial number J11, a store identifier J12, the print data received in step SB1, and the printed text data generated in step SB3, to the control server 15 (step SB4).

The serial number J11 is an identifier uniquely assigned to the printer 12 when the printer 12 is manufactured, and is stored in a specific storage area of the printer storage 32. In step SB4, the printer controller 30 acquires the serial number J11 from the specific storage area of the printer storage 32.

The store identifier J12 is information identifying the store where the printer 12 is used, and is stored in a specific storage area of the printer storage 32. In step SB4, the printer controller 30 acquires the store identifier J12 from the specific storage area of the printer storage 32.

Note that in step SB4, information related to communication required to transmit the serial number J11 (information related to the destination, the protocol used for communication, and the format of the transmitted data, for example) is previously registered in the printer 12.

As shown in FIG. 3 column FC, the control server controller 40 of the control server 15 controls the control server network communicator 41 to receive the serial number J11, store identifier J12, print data, and the printed text data that were transmitted by the printer 12 (step SC1).

Next, the control server controller 40 references the parser management database 421 (described below), and acquires a parser set PSS related to the same serial number J11 as the serial number J11 received in step SC1 (step SC2).

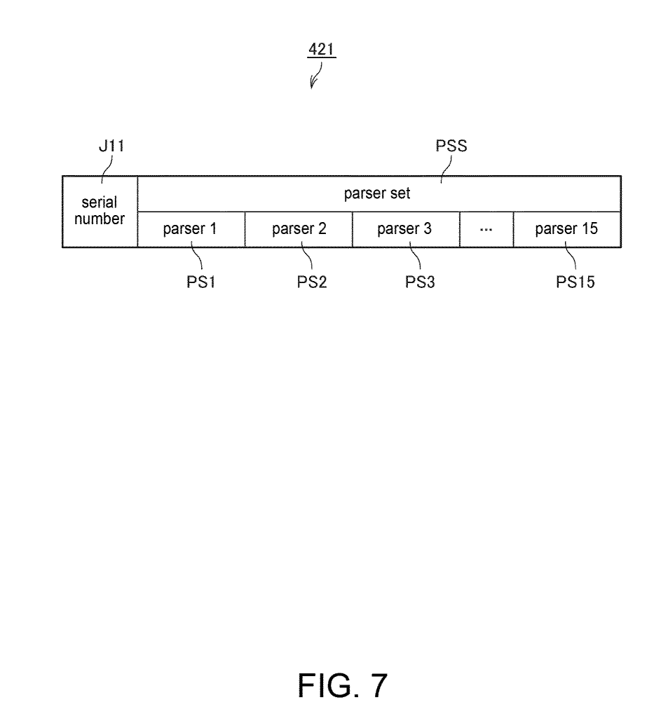

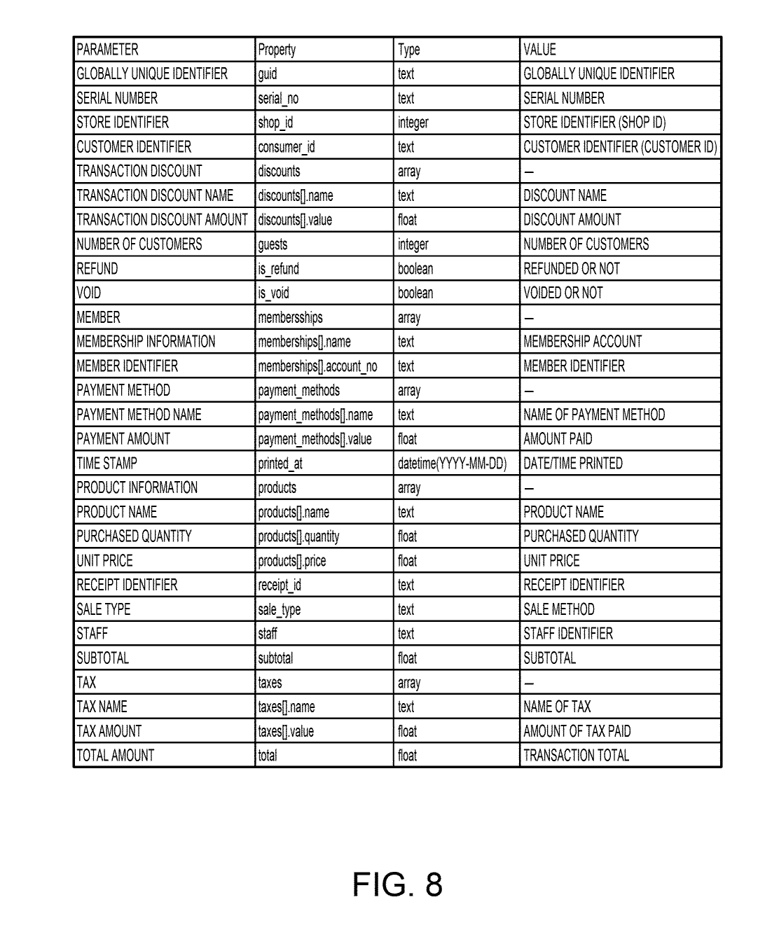

FIG. 7 schematically illustrates the information stored in one record of the parser management database 421.

As shown in FIG. 7, each record in the parser management database 421 stores a serial number J11 and parser set PSS. The parser set PSS in this example stores 15 parsers PS, parser 1 PS1 to parser 15 PS15. These parsers PS, parser 1 PS1 to parser 15 PS15, are described further below.

Next, the control server controller 40 executes a text data analysis process based on the acquired parser set PSS (step SC3).

The text data analysis process executed in step SC3 is a process of analyzing the printed text data based on the parser set PSS, and for multiple predetermined parameters, acquiring the parameter value, or determining that the parameter value cannot be acquired. The parameters for which a parameter value is acquired in the text data analysis process of step SC3 are below referred to as receipt parameters.

There are fifteen receipt parameters in this example as described below. Note that herein a “property” represents the corresponding property when the parameters are written as data (analytical data, response data) in JSON format. Receipt parameter details are described further below.

customer identifier parameter (consumer_id property)

transaction discount parameter (discounts property)

number of customers parameter (guests property)

refund parameter (is_refund property)

void parameter (is_void property)

member parameter (memberships property)

payment method parameter (payment_methods property)

time stamp parameter (printed_at property)

product information parameter (products property)

receipt identifier parameter (receipt_id property)

sale type parameter (sale_type property)

staff parameter (staff property)

subtotal parameter (subtotal property)

tax parameter (taxes property)

total amount parameter (total property)

The parser set PSS comprises a parser PS for each receipt parameter. The parser PS corresponding to a receipt parameter is a program that analyzes the printed text data, and acquires the parameter value of that receipt parameter, or detects that the parameter value cannot be acquired. In this embodiment, the parser set PSS includes: a parser 1 P1 that acquires the parameter value of the customer identifier parameter; parser 2 P2 that acquires the parameter value of the transaction discount parameter; parser 3 P3 that acquires the parameter value of the number of customers parameter; parser 4 P4 that acquires the parameter value of the refund parameter; parser 5 P5 that acquires the parameter value of the void parameter; parser 6 P6 that acquires the parameter value of the member parameter; parser 7 P7 that acquires the parameter value of the payment method parameter; parser 8 P8 that acquires the parameter value of the time stamp parameter; parser 9 P9 that acquires the parameter value of the product information parameter; parser 10 P10 that acquires the parameter value of the receipt identifier parameter; parser 11 P11 that acquires the parameter value of the sale type parameter; parser 12 P12 that acquires the parameter value of the staff parameter; parser 13 P13 that acquires the parameter value of the subtotal parameter; parser 14 P14 that acquires the parameter value of the tax parameter; and parser 15 P15 that acquires the parameter value of the total amount parameter.

The text data analysis process is embodied by a specific control program installed on the control server 15, and functions of programs associated with the control program. Parser 1 P1 to parser 15 P15 are programs that can be called by the specific program, and is written in a specific script language.

In the text data analysis process executed in step SC3, the control server controller 40, based on parser 1 PS1 to parser 15 PS15 included in the parser set PSS, acquires the parameter value for each of the fifteen receipt parameters, or detects that the parameter value cannot be acquired.

Next, the control server controller 40 generates analytical data based on the results of the text data analysis process in step SC3 (step SC4).

The analytical data is data in JSON format relating parameter values to each of the receipt parameters described above and the parameters described below.

globally unique identifier parameter (guid property)

serial number parameter (serial_no property)

store identifier parameter (shop_id property)

The parameters (referred to below as analytical parameters) written as parameters in the analytical data are described below.

FIG. 8 is a table used to describe the analyzed elements.

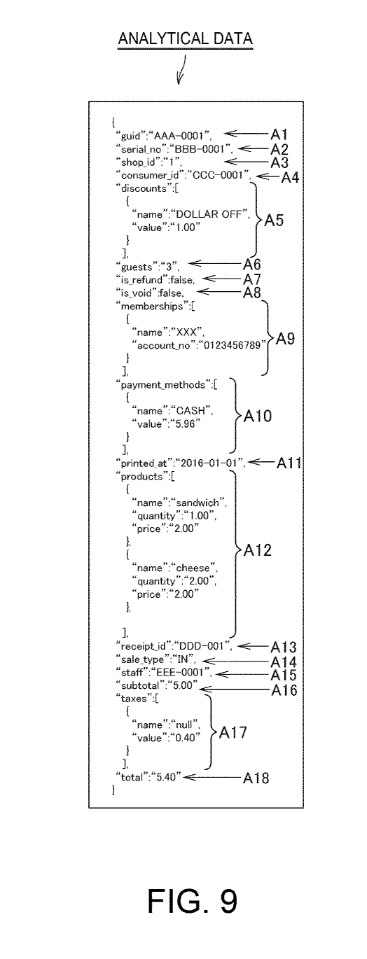

FIG. 9 shows an example of analytical data.

As shown in FIG. 8, the globally unique identifier parameter is an element corresponding to the guid property of data type: text. The parameter value of the globally unique identifier parameter is an identifier (referred to below as globally unique identifier J15) uniquely identifying an analytical data object. When generating analytical data, the control server controller 40 creates a globally unique identifier J15 of data type: text according to specific rules, and stores the globally unique identifier J15 paired with the globally unique identifier key.

In the analytical data shown in FIG. 9, the guid property is written in line A1.

As shown in FIG. 8, the serial number parameter corresponds to the serial_no property of data type: text. The parameter value of the serial number parameter is serial number J11. When generating analytical data, the control server controller 40 converts the serial number J11 received in step SC1 to a data type: text value as required, and writes the serial number J11 paired with the serial number key.

In the analytical data shown in FIG. 9, the serial_no property is written to line A2.

As shown in FIG. 8, the store identifier parameter is an element corresponding to the shop_id property of data type: integer. The parameter value of the store identifier parameter is the store identifier J12. When generating analytical data, the control server controller 40 converts the store identifier J12 acquired in step SC1 to data type: integer as necessary, and writes the store identifier J12 in the analytical data paired with the store identifier key.

In the analytical data shown in FIG. 9, the shop_id property is written to line A3.

As shown in FIG. 8, the customer identifier parameter is an element corresponding to the consumer_id property of data type: text. The parameter value of the customer identifier parameter is information identifying the customer in the transaction (referred to below as the customer identifier J16).

A customer card storing the customer identifier J16 is read during the transaction, and the customer identifier J16 may be printed on the receipt. In this case, the customer identifier J16 is included in the receipt information, and a string identifying the customer identifier J16 is written to the printed text data.

In the text data analysis process of step SC3, the control server controller 40 interprets the printed text data by a function of parser 1 PS1, and acquires the customer identifier J16, or determines the customer identifier J16 cannot be acquired. When generating analytical data, the control server controller 40, if the customer identifier J16 was acquired in the text data analysis process, writes the acquired customer identifier J16 in the analytical data paired with the customer identifier key. When generating analytical data, the control server controller 40, if the customer identifier J16 could not be acquired in the text data analysis process, writes the null value paired with the customer identifier parameter key.

In the analytical data shown in FIG. 9, the consumer_id property is written to line A4.

As shown in FIG. 8, the transaction discount parameter is an element corresponding to the discounts property of data type: array. The parameter value of the transaction discount parameter includes a transaction discount name element and transaction discount amount element.

The transaction discount name element corresponds to the discounts[ ].name property of data type: text. The value of the transaction discount name element is information identifying the name of the discount applied to the transaction (referred to below as transaction discount name J17).

The transaction discount amount element corresponds to the discounts[ ].value property of data type: float. The value of the transaction discount amount element is information identifying the value of the discount applied to the transaction (referred to below as transaction discount amount J18).

A specific discount may be applied to a transaction. In this event, the transaction discount name J17 and transaction discount amount J18 corresponding to the specific discount applied to the transaction may be printed on the receipt. In this event, the transaction discount name J17 and transaction discount amount J18 are included in the receipt information, and a string indicating the transaction discount name J17, and a string indicating the transaction discount amount J18, are written to the printed text data.

In the text data analysis process of step SC3, the control server controller 40 interprets the printed text data by a function of parser 2 PS2, and acquires the transaction discount name J17 and transaction discount amount J18, or determines they cannot be acquired.

When generating analytical data, the control server controller 40, if the transaction discount name J17 was acquired in the text data analysis process, writes the acquired transaction discount name J17 in the analytical data paired to the transaction discount name element key. When generating analytical data, the control server controller 40, if the transaction discount name J17 could not be acquired in the text data analysis process, writes the null value paired with the transaction discount name element key.

When generating analytical data, the control server controller 40, if the transaction discount amount J18 was acquired in the text data analysis process, tries to convert the data type of the acquired transaction discount amount J18 to data type: float. If the transaction discount amount J18 is not information combining numeric characters and specific symbols (including a symbol denoting a decimal point), the data type cannot be converted to data type: float. If the data type can be converted, the control server controller 40 writes the transaction discount amount J18 with the converted data type paired with the transaction discount amount element key in the analytical data. If the data type cannot be converted, the control server controller 40 writes the null value paired with the transaction discount amount element key.

When generating analytical data, the control server controller 40, if the transaction discount amount J18 could not be acquired in the text data analysis process, writes the null value paired with the transaction discount name element key.

In the analytical data shown in FIG. 9, the discounts property is written to line A5.

As shown in FIG. 8, the number of customers parameter is an element corresponding to the guests property of data type: integer. The parameter value of the number of customers parameter indicates the number of customers involved in the transaction (referred to below as the number of customers J19).

The number of customers parameter is described further below.

In the analytical data shown in FIG. 9, the guests property is written to line A6.

As shown in FIG. 8, the refund parameter is an element corresponding to the is_refund property of data type: boolean. The parameter value of the refund parameter may be true, indicating that a refund was made in the transaction, or false, indicating that a refund was not made in the transaction.

For the refund parameter, the control server controller 40 executes the same process executed for the void parameter as described below. Further detailed description of the refund parameter is omitted here.

In the analytical data shown in FIG. 9, the is_refund property is written to line A7.

As shown in FIG. 8, the void parameter is an element corresponding to the is_void property of data type: boolean. The parameter value of the void parameter may be true, indicating the transaction was voided, or false, indicating the transaction was not voided.

A transaction may be voided. In this event, information indicating that the transaction was voided may be printed on the receipt. In this case, a string indicating that the transaction was voided is written to the printed text data.

In the text data analysis process of step SC3, the control server controller 40 interprets the printed text data by a function of parser 5 PS5, and determines if a string indicating that the transaction was voided is written to the printed text data. If the voided string is written, the control server controller 40 determines the value of the void parameter is true. If the voided string is not written, the control server controller 40 determines the value of the void parameter is false.

When generating analytical data, the control server controller 40 writes either true or false as the value paired with the void parameter key.

In the analytical data shown in FIG. 9, the is_void property is written to line A8.

As shown in FIG. 8, the member parameter is an element corresponding to the memberships property of data type: array. The member parameter includes a membership information element and a member identifier element.

The membership information element is an element corresponding to the memberships[ ].name property of data type: text. The parameter value of the membership information element is information identifying the name of the service program to which the customer belongs (referred to below as membership information J20).

The member identifier element is an element corresponding to the memberships[ ].account.no” property of data type: text. The parameter value of the member identifier element is information identifying the customer in the service program to which the customer belongs (referred to below as member identifier J21).

Further detailed description of the member parameter is omitted.

In the analytical data shown in FIG. 9, the memberships property is written to line A9.

As shown in FIG. 8, the payment method parameter is an element corresponding to the payment_methods property of data type: array. The payment method parameter includes a payment method name element and a payment amount element.

The payment method name element is an element corresponding to the payment_methods[ ].name property of data type: text. The parameter value of the payment method name element is information indicating the name of the payment method (referred to below as the payment method name J22).

The payment amount element corresponds to the payment_methods[ ].value property of data type: float. The parameter value of the payment amount element is information indicating the amount the customer paid by the method identified by the payment method name J22 (referred to below as payment amount J23).

Further description of the payment method parameter is omitted.

In the analytical data shown in FIG. 9, the payment_methods property is written to line A10.

As shown in FIG. 8, the time stamp parameter corresponds to the printed_at property of data type: datetime(YYYY-MM-DD). The parameter value of the time stamp parameter is the time stamp J5.

In the text data analysis process of step SC3, the control server controller 40 interprets the printed text data by a function of parser 8 PS8, and acquires the time stamp J5 or determines it cannot be acquired. When generating analytical data, the control server controller 40, when the time stamp J5 is acquired in the text data analysis process and the data type is successfully converted, writes the time stamp J5 of the converted data type in the analytical data paired to the time stamp parameter. When generating analytical data, the control server controller 40, when the time stamp J5 is acquired in the text data analysis process and the data type is not successfully converted, writes the null value in the analytical data paired to the time stamp parameter. When generating analytical data, the control server controller 40, when the time stamp J5 cannot be acquired in the text data analysis process, writes the null value in the analytical data paired to the time stamp parameter.

In the analytical data shown in FIG. 9, the printed_at property is written to line A11.

As shown in FIG. 8, the product information parameter is an element corresponding to the products property of data type: array. The product information parameter includes a product name element, purchased quantity element, and unit price element.

The product name element corresponds to the products[ ].name property of data type: text. The parameter value of the product name element is the product name information J62.

The purchased quantity element corresponds to the products[ ].quantity property of data type: text. The parameter value of the purchased quantity element is purchased quantity information J61.

The unit price element corresponds to the products[ ].price property of data type: text. The parameter value of the unit price element is price information J63.

In the text data analysis process of step SC3, the control server controller 40, by a function of parser 9 PS9, interprets the printed text data and acquires the product name information J62, purchased quantity information J61, and price information J63, or determines the values cannot be acquired. When generating analytical data, the control server controller 40 writes the values of the product name information J62, purchased quantity information J61, and price information J63 that were successfully acquired in the analytical data, and writes the null value to the analytical data for the information that could not be acquired.

In the analytical data shown in FIG. 9, the products property is written to line A12.

As shown in FIG. 8, the receipt identifier parameter is an element corresponding to the receipt_id property of data type: text. The parameter value of the receipt identifier parameter is receipt identifier J42.

The control server controller 40 executes the same process for the receipt identifier parameter as for the customer identifier parameter. Further details about the receipt identifier parameter are omitted.

In the analytical data shown in FIG. 9, the receipt_id property is written to line A13.

As shown in FIG. 8, the sale type parameter is an element corresponding to the sale type property of data type: text. The parameter value of the sale type parameter is information indicating how the sale was made (referred to as the sale method J24). Further details about the sale type parameter parameter are omitted.

In the analytical data shown in FIG. 9, the sale type property is written to line A14.

As shown in FIG. 8, the staff parameter is an element corresponding to the staff property of data type: text. The parameter value of the staff parameter is information indicating the name of the employee (staff member) in the store or an identifier identifying the employee (referred to below as employee identifier J25). The employee may be the person that handled the transaction, or the person that provided the service to the customer in the store. Further details about the staff parameter parameter are omitted.

In the analytical data shown in FIG. 9, the staff property is written to line A15.

As shown in FIG. 8, the subtotal parameter corresponds to the subtotal property of data type: float. The parameter value of the subtotal parameter is subtotal information J72.

The control server controller 40 executes the same process for the subtotal parameter as for the total amount parameter described below. Further description of the subtotal parameter is omitted.

In the analytical data shown in FIG. 9, the subtotal property is written to line A16.

As shown in FIG. 8, the tax parameter is an element corresponding to the taxes property of data type: array. The tax parameter includes a tax name element and tax amount element.

The tax name element corresponds to the taxes[ ].name property of data type: text. The parameter value of the tax name element is information indicating the name of the tax (referred to below as the tax name J26). The tax name J26 may be printed on the receipt. In this case, the tax name J26 is included in the receipt information, and a string indicating the tax name J26 is written in the printed text data.

The tax amount element corresponds to the taxes.value property of data type: float. The parameter value of the tax amount element is tax information J82.

The control server controller 40 executes the same process for the tax parameter as for the transaction discount parameter described above. Further description of the tax amount element is omitted.

In the analytical data shown in FIG. 9, the taxes property is written to line A17.

As shown in FIG. 8, the total amount parameter corresponds to the total property of data type: float. The parameter value of the total amount parameter is transaction total information J92.

In the text data analysis process of step SC3, the control server controller 40 interprets the printed text data by a function of parser 15 PS15, and acquires the transaction total information J92 or determines it could not be acquired.

When generating analytical data, the control server controller 40, when the transaction total information J92 is acquired in the text data analysis process and the data type is successfully converted, writes the transaction total information J92 of the converted data type in the analytical data paired to the time total amount parameter. When generating analytical data, the control server controller 40, when the transaction total information J92 is acquired in the text data analysis process and the data type is not successfully converted, writes the null value in the analytical data paired to the total mount parameter. When generating analytical data, the control server controller 40, when the transaction total information J92 cannot be acquired in the text data analysis process, writes the null value in the analytical data paired to the total amount parameter.

In the analytical data shown in FIG. 9, the total property is written to line A18.

As shown in FIG. 3 column FC, after generating the analytical data in step SC4, the control server controller 40 creates a record in the analytical data management database 422 (step SC5).

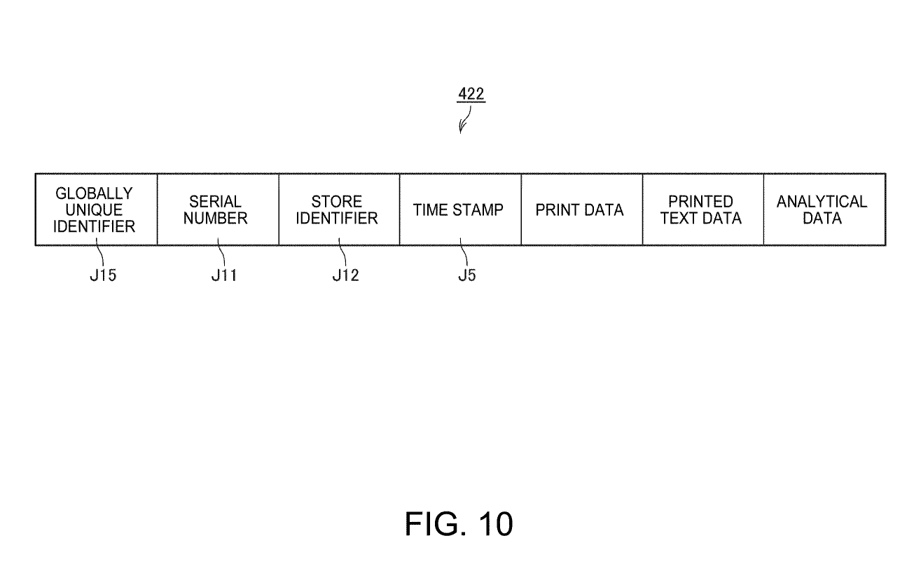

FIG. 10 schematically illustrates the information stored in each record of the analytical data management database 422.

As shown in FIG. 10, each record in the analytical data manager database 422 stores a globally unique identifier J15, serial number J11, store identifier J12, time stamp J5, print data, printed text data, and analytical data.

In step SC5, the control server controller 40 creates in the analytical data manager database 422 a record storing the globally unique identifier J15, serial number J11, store identifier J12, and time stamp J5 written to the corresponding elements in the analytical data, together with the printed text data and generated analytical data.

Multiple Web APIs (Application Programming Interfaces) are installed on the control server 15. The control server 15, in response to a request from a browser on an external device, executes processes through the installed Web APIs based on the analytical data manager database 422, and provides the information required by the user.

For example, the control server controller 40 of the control server 15, in response to a request from a browser on an external device, provides the transaction total information J92 related to a specific receipt using the analytical data from the analytical data manager database 422.

As described above, the control server controller 40 of the control server 15, by functions of parsers PS, interprets the printed text data, and acquires the values corresponding to parameters (elements), or determines that certain parameter values cannot be acquired. As described above, the receipt layout may change when the printer 12 changes. Therefore, the parser PS that interprets the printed text data sent from one printer 12 must execute a process reflecting the layout used by that printer 12 to acquire the values for the corresponding parameters.

As a result, by executing the process described below, a control server 15 according to this embodiment enables a user to generate, by a simple operation, a parser PS having the ability to appropriately acquire parameter values reflecting the layout used by a particular printer 12.

The process whereby the control server 15 generates the following parsers PS for one printer 12 based on a user operation is described below.

The parsers PS generated in this example are parser 15 PS15 (a parser PS for acquiring the parameter values of the total amount parameter (total property)); parser 5 PS5 (a parser PS for acquiring the parameter values of the void parameter (is_void property)); and parser 9 PS9 (a parser PS for acquiring the parameter values of the product information parameter (products property)).

In this example, the control server 15 displays a user interface on the display panel of the control server 15 in response to operation of an input means of the control server 15. However, a configuration is also conceivable in which the user performs a specific operation on an external device that can communicate with the control server 15, and the control server 15, in response to a request from the external device, presents a user interface on the external device.

To create a parser PS, the user operates an input means of the control server 15, and instructs displaying a first user interface UI1. In response to the user command, the control server controller 40 controls the control server display 43 to display the first user interface UI1 on the display panel.

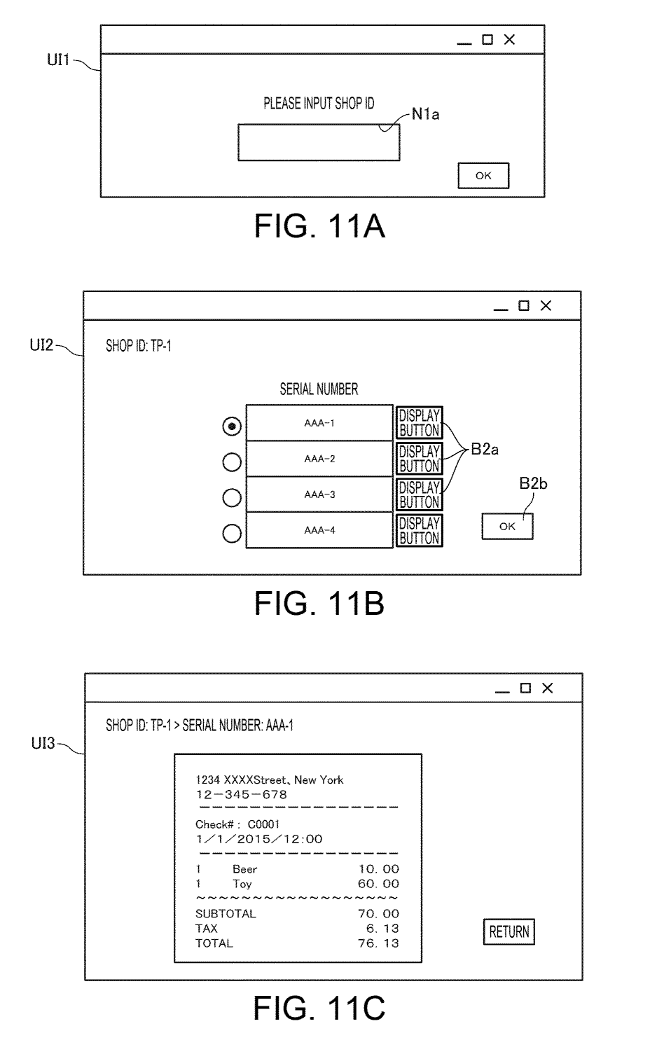

FIG. 11A shows an example of the first user interface UI1.

As shown in FIG. 11A, the first user interface UI1 has an input field N1a for inputting a store identifier J12. In this example, the user inputs to the input field N1a the store identifier J12 of the store where the printer 12 for which to generate a parser PS, and then confirms input.

In response to the input, the control server controller 40 controls the control server display 43 to display a second user interface UI2 on the display panel.

FIG. 11B shows an example of a second user interface UI2.

As shown in FIG. 11B, the second user interface UI2 displays the store identifier J12 input by the user.

The second user interface UI2 displays a list including the serial number J11 of any printer 12 for which the parameter value of any required parameter (described below) has not been acquired from the group of printers 12 installed in the store identified by the store identifier J12 input by the user. That the parameter value of a required parameter has not been acquired means that the parameter value of a required parameter cannot be acquired by a function of the parser PS corresponding to that required parameter.

A radio button for each serial number J11 is displayed in the second user interface UI2. Using the radio buttons, the user can select any one serial number J11. A Display button B2a for each radio button is also displayed in the second user interface UI2. The Display button B2a is a button for instructing displaying the text written in the printed text data received from the printer 12 for the corresponding serial number J11. The second user interface UI2 also has an OK button B2b for confirming the serial number J11 selected by the radio button.

A required parameter as used herein is any receipt parameter for which the parameter value is to be acquired by the function of a parser PS. More specifically, a required parameter is a parameter for which the null value is not stored in the analytical data generated based on the printed text data. In this example, the time stamp parameter (printed_at property), product information parameter (products property), receipt identifier parameter (receipt_id property), tax parameter (taxes property), and total amount parameter (total property) are required parameters.

The required parameters of the receipt information are selected based on whether or not the parameter is important for interpreting the transaction for which the receipt was issued.

The control server controller 40 references the printer management database 423 to display the second user interface UI2. The printer management database 423 stores a record for each printer 12.

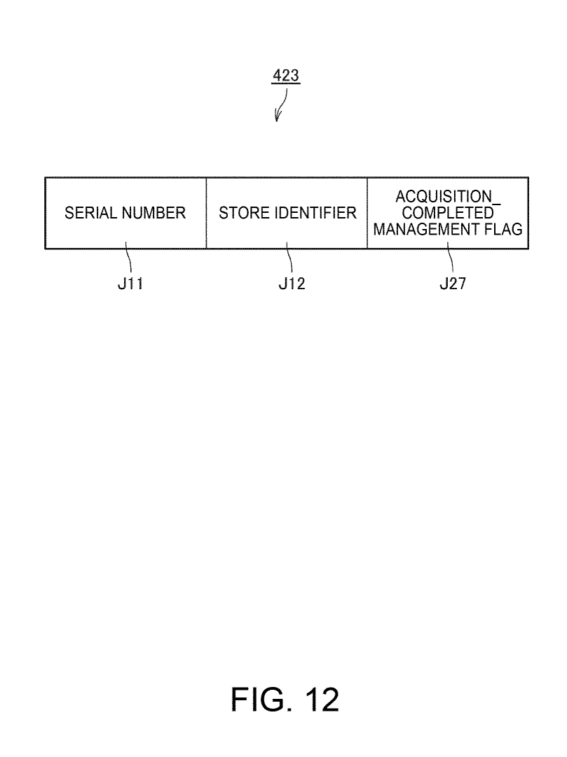

FIG. 12 schematically shows the information in each record of the printer management database 423.

As shown in FIG. 12, each record in the printer management database 423 includes a serial number J11, store identifier J12, and acquisition completed management flag J27 (described further below).

Each printer 12 record in the printer management database 423 includes the serial number J11 of the printer 12, the store identifier J12 of the store in which the printer 12 is deployed, and the acquisition_completed management flag J27 for the printer 12. The acquisition_completed management flag J27 for a particular printer 12 stores a value indicating that all required parameters could be acquired by the functions of the parsers PS for that printer 12 based on the printed text data the printer 12 sent, or a value indicating if any one required parameter value could not be acquired for that printer 12.

The control server controller 40 changes the value of the acquisition_completed management flag J27 appropriately based on whether or not all required parameters could be acquired.

The user may also be enabled to change the value of the acquisition_completed management flag J27.

When displaying the second user interface UI2, the control server controller 40 references the printer management database 423, and acquires and displays a list of the serial number J11 of each printer 12 for which the parameter value of any required parameter could not be acquired in the store identified by the store identifier J12 input by the user.

When operation of the Display button B2a in the second user interface UI2 is detected, the control server controller 40 controls the control server display 43 to display the third user interface UI3 on the display panel.

FIG. 11C shows an example of a third user interface UI3.

As shown in FIG. 11C, the third user interface UI3 displays text based on the printed text data.

To display the third user interface UI3, the control server controller 40 references the analytical data manager database 422 and acquires the printed text data received from the printer 12 of the serial number J11 corresponding to the Display button B2a that was operated. For example, the control server controller 40 may acquire the printed text data that was most recently received from a printer 12. Next, the control server controller 40 presents a third user interface UI3 displaying the text written in the acquired printed text data. Note that the control server controller 40 may be configured to prompt the user to select one instance of printed text data received from the printer 12, and acquire the instance of printed text data selected by the user.

The user, by reading the third user interface UI3, can then know the content of the information written in the printed text data, and the layout of the corresponding receipt.

By performing a specific operation on the third user interface UI3, the user can change the user interface that is displayed from the third user interface UI3 to the second user interface UI2.

When operation of the OK button B2b in the second user interface UI2 is detected, the control server controller 40 controls the control server display 43 to display a fourth user interface UI4 on the display panel.

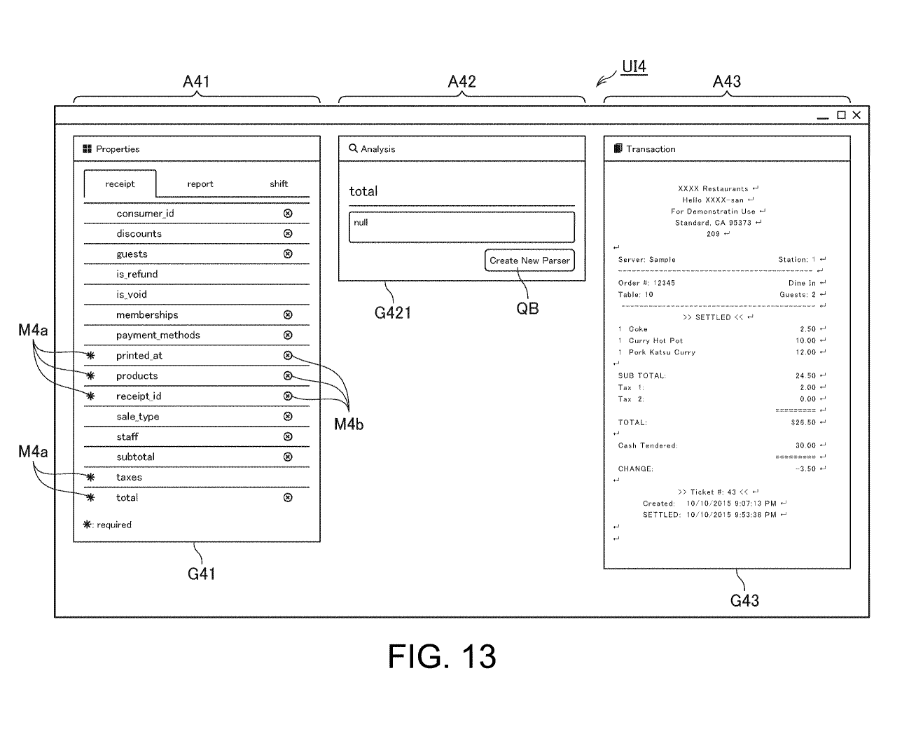

FIG. 13 shows an example of a fourth user interface UI4.

As shown in FIG. 13, the fourth user interface UI4 is divided into three areas, first area A41, second area A42, and third area A43.

The information displayed in each area, and the process of the control server controller 40 when displaying the information, are described below sequentially from first area A41 to second area A42 and third area A43.

### First Area A41

The first area A41 is described first.

An element selection group G41 is displayed in the first area A41 of the fourth user interface UI4. As shown in FIG. 13, the element selection group G41 displays the property names of the fifteen elements printed on a receipt described above so that desired elements can be selected.

Some of the receipt elements for which the property name is displayed in the element selection group G41 are required receipt elements, and required elements are flagged with a specific mark M4a (first additional information) beside the property name. In the example in FIG. 13, the mark M4a is an asterisk, and the required elements are “printed_at”, “products”, “receipt_id”, “taxes”, and “total”.

Acquiring the parameter value may not be completed for some of the receipt elements for which the property name is displayed in the element selection group G41. In the example shown in FIG. 13, receipt elements for which the parameter value has not been acquired are flagged with a mark M4b (second additional information) having an “x” inside a circle displayed beside the property names, “consumer_id”, “discounts”, “memberships”, “payment_methods”, “products”, “sale_type”, and “subtotal”. Elements for which the parameter value has not been acquired are elements for which the null value was stored relationally to the corresponding parameter in the analytical data generated a function of the appropriate parser PS. These elements are equivalent to parameters for which the parameter value could not be acquired.

The user can select individual elements displayed in the element selection group G41 by performing a specific operation, such as pointing a cursor at the desired element and double clicking a mouse. The element selected by the user is indicated by a rectangle displayed surrounding the property name. The user can move the cursor in the fourth user interface UI4 and other user interfaces using a mouse, keyboard, or other input device.

By referencing the element selection group G41, the user can easily and directly know the required elements, and can easily and directly know the elements for which the parameter value could not be acquired.

To display the element selection group G41, the control server controller 40 references the analytical data manager database 422, and acquires the printed text data received from the printer 12 of the serial number J11 selected by the user in the second user interface UI2. When the Display button B2a in the second user interface UI2 is operated, the control server controller 40 acquires the printed text data to be displayed as text in the third user interface UI3.

Below, the printer 12 of the serial number J11 selected by the user in the second user interface UI2 is referred to as the selected printer. The acquired printed text data is referred to as the text data to process.

Next, the control server controller 40 references the parser management database 421 and acquires the parser set PSS of the selected printer. Next, the control server controller 40, by functions of the acquired parser set PSS, analyze the text data to process, and for each receipt element determines if the parameter value can be acquired or cannot be acquired.

That the parameter value of one element can be acquired means that, in the analytical data generated based on analyzing the text data to process, a value other than the null value is stored for that parameter. That the parameter value of one element cannot be acquired means that, in the analytical data generated based on analyzing the text data to process, the null value is stored for that parameter.

Next, based on this decision, the control server controller 40 displays a element selection group G41 with marks M4b at the appropriate positions in the first area A41.

### Third Area A43

The third area A43 is described next.

A text display pane G43 is displayed in the third area A43 of the fourth user interface UI4. The text display pane G43 contains the text written in the text data to process.

As described above, the text data to process (printed text data) is text data containing the information printed as text on the receipt written in a form reflecting the order in which it is printed and any carriage returns inserted when printing. The information contained in the text displayed in the text display pane G43 therefore is arranged in the same order as the layout of the receipt. By reading the text display pane G43, the user can therefore easily and directly know the content of the information written in the text data to process, and the layout of the corresponding receipt.

In the text display pane G43, the text based on the text data to process is displayed so that words (described below) can be selected as keywords (described below).

Words are described below. Below, the character code representing a carriage return (new line) is referred to as a “return character.”

Character types as used herein include delimiter characters, special characters, and regular characters.

Delimiter characters include space and return characters. As described below, delimiter characters are used to delimit one word from another word.

Special characters are specific predefined symbols. Special characters are characters that may be used in information with special meaning. In this example, special characters include the hyphen (-), tilde (˜), equal sign (=), and colon (:) characters.

Regular characters are characters other than delimiter characters and special characters.

A “word” is (1) a string of consecutive regular characters uninterrupted by a delimiter character (the string may consist of a single character, and a single character may be referred to as a string below as may be appropriate); of (2) a string of consecutive special characters uninterrupted by a delimiter character.

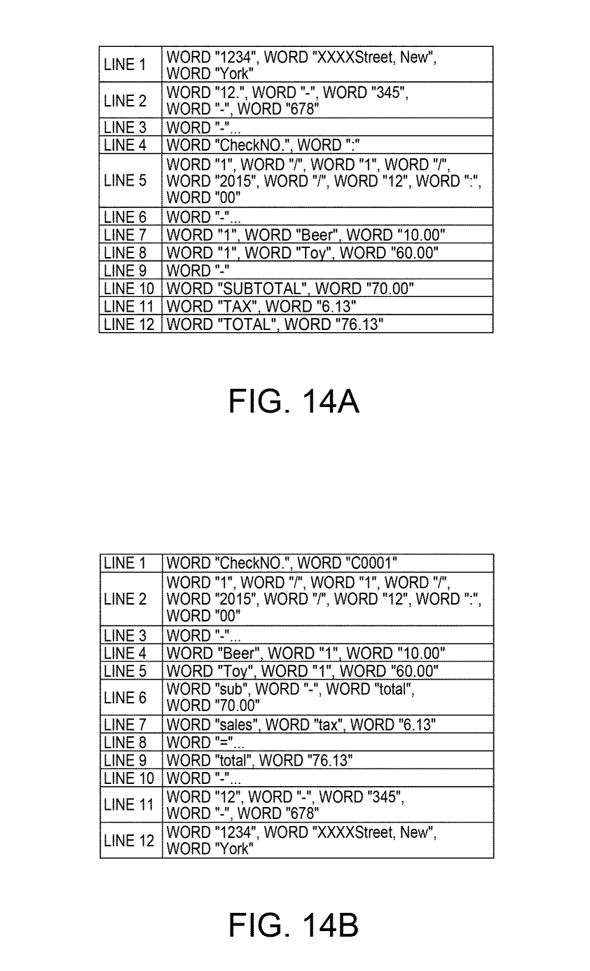

FIG. 14A is a table listing, line by line, the words contained in the printed text data T1 in FIG. 6A.

FIG. 14B is a table listing, line by line, the words contained in the printed text data T2 in FIG. 6B.

For example, in the case of printed text data T2 in FIG. 6B, the string CheckNO. corresponding to the receipt identification identifier J41, and the string C0001 corresponding to the receipt identifier J42, are both strings of consecutive regular characters uninterrupted by a delimiter character. These strings are therefore “words.”

Other examples of words in the printed text data T2 in FIG. 6B are the strings “sub”, “-”, and “total” forming the subtotal identifier J71. The string “sub” is a string of consecutive regular characters uninterrupted by a delimiter character. The string “-” is a string of consecutive special characters uninterrupted by a delimiter character. The string “total” is a string of consecutive regular characters uninterrupted by a delimiter character. The subtotal identifier J71 is therefore information comprising three consecutive words.

The area break information is a string of consecutive special characters uninterrupted by a delimiter character. The area break information is therefore another example of a word.

To display the text display pane G43, the control server controller 40 deconstructs the information included in the text data to process into words. Next, the control server controller 40 displays in the text display pane G43 the text written in the text data to process in a form enabling individually selecting the deconstructed words and space characters as keywords (described below). This is further described below.

As will become clear below, this embodiment enables selecting a space character as part of a keyword. As a result, space characters are included in words.

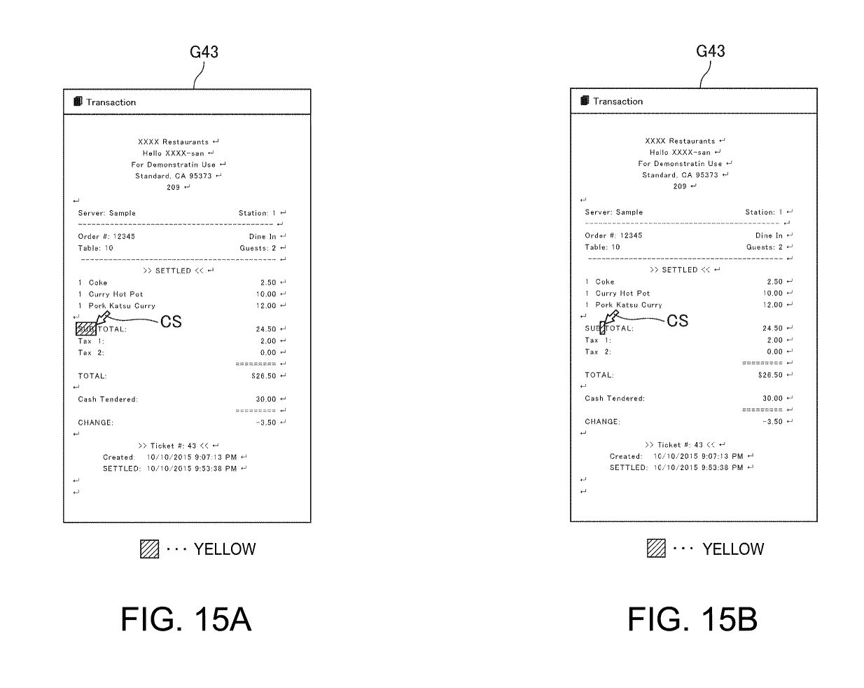

FIG. 15A and FIG. 15B show examples of the text display pane G43 together with a cursor CS that the user can move.

When the cursor CS is over a word or space character in the control server display 43, the control server controller 40 converts the background color of the background to the word or space character to a specific color (in this example, yellow; that is, applies a specific style).

FIG. 15A shows when the cursor CS is over the area of the word SUB. As shown in FIG. 15A, when the cursor CS is over the area of the word SUB, the background color of that area changes to yellow.

FIG. 15B shows when the cursor CS is over the area of the word TOTAL. As shown in FIG. 15B, when the cursor CS is over the area of the word TOTAL, the background color of that area changes to yellow.

The style applied to the word over which the cursor CS hovers (the word selected as a candidate) is not limiting to changing the background color. The string corresponding to the selected word may be changed to bold, or emphasis marks or underlining may be applied.

Words or spaces over which the cursor hovers when selecting keywords described below (or part of a keyword as described below) are the words or spaces that are candidates for selection as keywords. By moving the cursor over a desired word or space, checking that the background color of the desired word or space turned yellow, and then confirming that the desired word or space is selected as a keyword candidate by then performing a specific operation (such as double clicking the mouse) confirming the selection, the user can reliably select the desired word or space as a keyword.

### Second Area A42

The second area A42 is described next.

Below, receipt elements selected by the user in the element selection group G41 of first area A41 are referred to as “selected receipt elements.”

In the second area A42 of the fourth user interface UI4 is displayed a panel for inputting or selecting information for generating a parser PS appropriate to the selected receipt elements.

By selecting or inputting information to the fields in the second area A42, the user can generate a parser PS appropriate to the selected receipt elements.

The information displayed in the second area A42, and the process of the control server 15, are described below when generating the parser 15 PS15 (when the selected receipt element is the total amount parameter), the parser 5 PS5 (when the selected receipt element is the void parameter), and the parser 9 PS9 (when the selected receipt element is the product information parameter).

### Parser 15 PS15

To generate the parser 15 PS15, the user selects from the element selection group G41 the total amount parameter (total property).

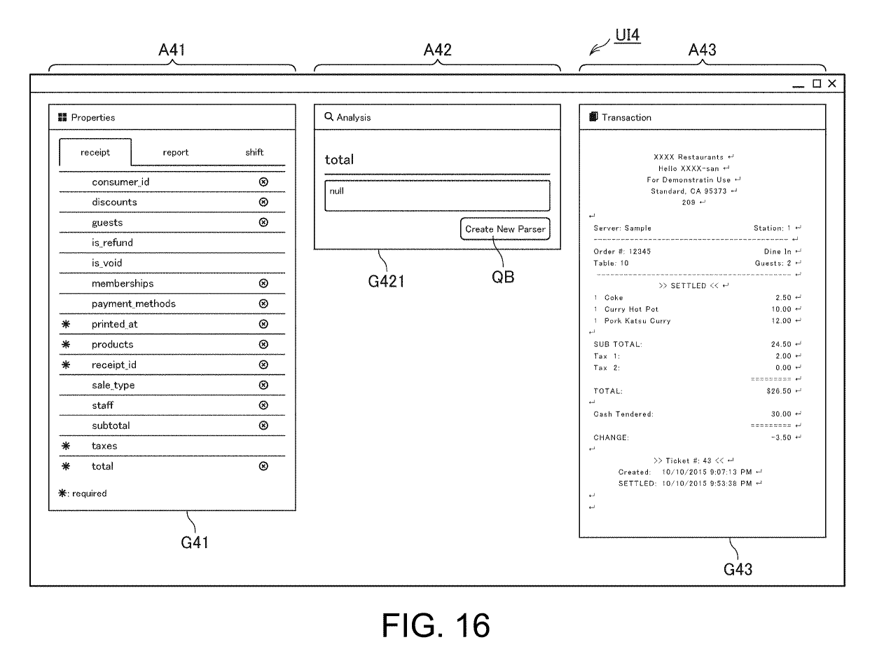

FIG. 16 illustrates the fourth user interface UI4 displayed when the total amount parameter was selected.

As shown in FIG. 16, when the total amount parameter is selected in the element selection group G41, an acquired parameter value display pane G421 is displayed. In the acquired parameter value display pane G421 is displayed the result (the value written in the analytical data for the total amount parameter) of the parser 15 PS15, which is correlated to the serial number J11 of the selected printer in the parser management database 421, interpreting the text data to process. In the example in FIG. 16, the null value is displayed in the element selection group G41, thereby indicating that at this time the parser 15 PS15 cannot acquire the transaction total information J92.

To display the acquired parameter value display pane G421, the control server controller 40 references the parser management database 421, and acquires the parser PS corresponding to the selected receipt elements for the selected printer. Using the acquired parser PS, the control server controller 40 interprets the text data to process, and based on the result, displays the acquired parameter value display pane G421.

Regardless of the selected receipt elements, the control server controller 40 in this embodiment displays the acquired parameter value display pane G421 in the second area A42, and of the parsers PS stored in the parser management database 421, displays the result of the parser PS corresponding to the selected receipt elements for the selected printer. This has the following effect.

That is, the user, by reading the acquired parameter value display pane G421, can easily and directly know the result of the parser PS for the selected receipt elements.

The text display pane G43 in the third area A43, and the acquired parameter value display pane G421 in the second area A42, are displayed simultaneously in the same user interface. As a result, the user can reference and compare the text display pane G43 and the acquired parameter value display pane G421. As a result, the user, by comparing the text display pane G43 and acquired parameter value display pane G421, can determine the appropriateness of the parser PS results interpreting for the selected receipt elements. For example, the user may compare the value displayed in the acquired parameter value display pane G421, and the value of the transaction total information J92 displayed in the text display pane G43, for the total amount parameter (total property), and determine if the corresponding parser PS was able to acquire the correct transaction total information J92. Furthermore, as described above, the sale method J24 may or may not not be printed on the receipt depending on the format of the receipt. If the receipt is formatted such that the sale method J24 is not printed, the result of interpretation by the corresponding parser PS is correctly null. As a result, if the result from the corresponding parser PS is the null value, the null value may actually be correct, and by comparing the text display pane G43 and acquired parameter value display pane G421 in this case, the user can determine that the null value is appropriate.

As shown in FIG. 16, in the acquired parameter value display pane G421 of the second area A42 is displayed a Create New Parser button QB instructing starting a process to create a parser PS corresponding to the selected receipt element for the selected printer.

When operation of the Create New Parser button QB is detected, the control server controller 40 displays the frame selection pane G422 while continuing to display the acquired parameter value display pane G421 in the second area A42.

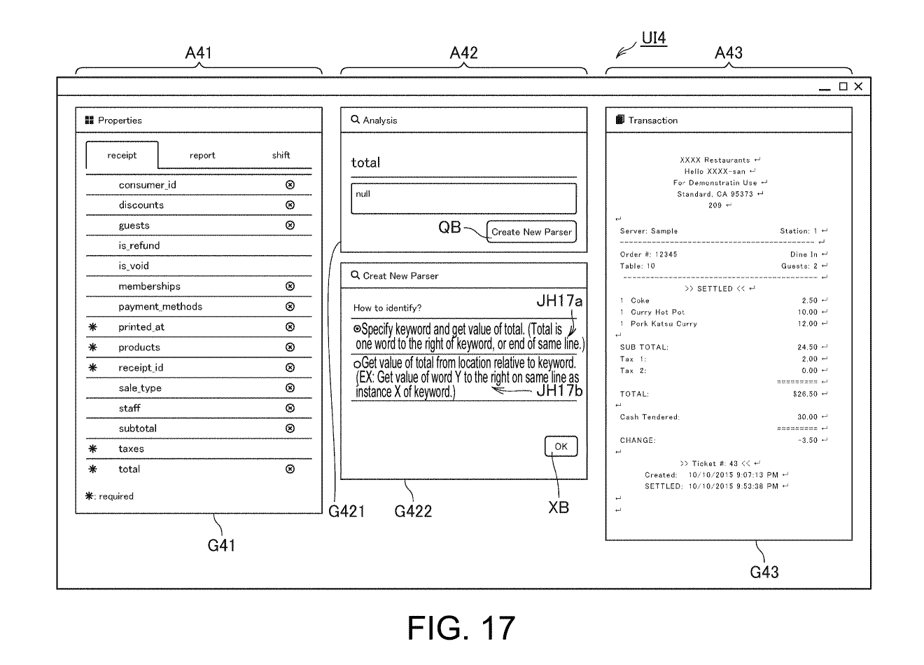

FIG. 17 shows the fourth user interface UI4 with the analytical data manager database 422 displayed in second area A42.

The frame selection pane G422 is a pane for selecting the type of rule used to determine the location in the printed text data of the parameter value corresponding to the selected receipt element.

As described above, information is printed on a receipt according to the specific layout of the receipt. Information corresponding to the parameter value of a particular parameter (element) is therefore written in the printed text data according to a rule reflecting the layout of the receipt and corresponding to that element. As a result, the location in the printed text data of the parameter value for a specific element can therefore be identified based on the rule corresponding to that element.

The rule used to identify the location of a parameter value in the printed text data is referred to below as a search rule.

There are multiple types of search rules, which differ by the method of identifying the location of the parameter value. For example, if the value of a specific parameter (element) is located on the right side on the same line as a specific keyword, the search rule is a rule of a type specifying that the value is on the right side of the specific keyword. However, if the value of a specific parameter (element) is located on the left side on the same line as a specific keyword, the search rule is a rule of a type specifying that the value is on the left side of the specific keyword.

The type of search rule is managed in this example using the concept of “frames.” Therefore, the frame selection pane G422 enables selecting one or more frames according to the type of one or more search rules corresponding to a specific selected receipt element.

In this example, one characteristic of the receipt layout is that a transaction total identifier J91 is printed with the transaction total information J92, and the transaction total identifier J91 and transaction total information J92 are in specific positions relative to each other. Based thereon, a first total amount information frame, and a second total amount information frame, can be selected as frames for the total amount parameter (total property).

The first total amount information frame is a frame corresponding to a search rule specifying that, on the same line as the transaction total identifier J91 selected as the keyword, the transaction total information J92 is located one position to the right of the transaction total identifier J91, or is located at the end of the same line.

That one parameter value is located one position to the right of a keyword on the same line as the keyword means that the parameter value is located on the right side of the keyword with one or more spaces in between. That one parameter value is located one position at the end of the same line as the keyword means that the parameter value is located on the right end of the same line, and the character after that value is a carriage return.

The second total amount information frame is a frame corresponding to a search rule that is different from the search rule of the first total amount information frame, and is a search rule specifying the location of the transaction total information J92 based on the position of the transaction total information J92 relative to the location of the transaction total identifier J91 selected as the keyword.

Frame information JH17a describing the first total amount information frame, and frame information JH17b describing the second total amount information frame, are presented in a list in the frame selection pane G422 in FIG. 17. A radio button is displayed beside the information for frame information JH17a and frame information JH17b. The user can use the radio buttons to select either first total amount information frame or second total amount information frame. By referring to the text display pane G43 displayed simultaneously with the frame selection pane G422, the user can determine whether the first total amount information frame or the second total amount information frame is appropriate to the receipt layout, and can easily select the appropriate frame.

As shown in FIG. 17, a frame confirmation button XB for confirming the frame selection is also displayed in the frame selection pane G422. When operation of the frame confirmation button XB is detected, the control server controller 40 overwrites the frame selection pane G422 with a step correlation pane G423.

Note that herein the frame selected by the user is referred to as the selected frame.

One or more steps are prepared for each frame. A step refers to the sequence of operations defining the search rule by selecting information related to the search rule corresponding to the frame or inputting information. One or more step correlation panels G423 are prepared for the one or more steps corresponding to the frame. The location of the parameter value in the printed text data may be specified based on multiple search rules. In this case, multiple step correlation panels G423 are prepared for one frame.

As will be understood below, the user, by a process of inputting information to the one or more step correlation panels G423 for the selected frame, can define one or more search rules required to find the parameter value corresponding to the selected receipt element.

This is further described below referring to two instances, when the selected frame is the first total amount information frame, and when the selected frame is the second total amount information frame.

### First Total Amount Information Frame

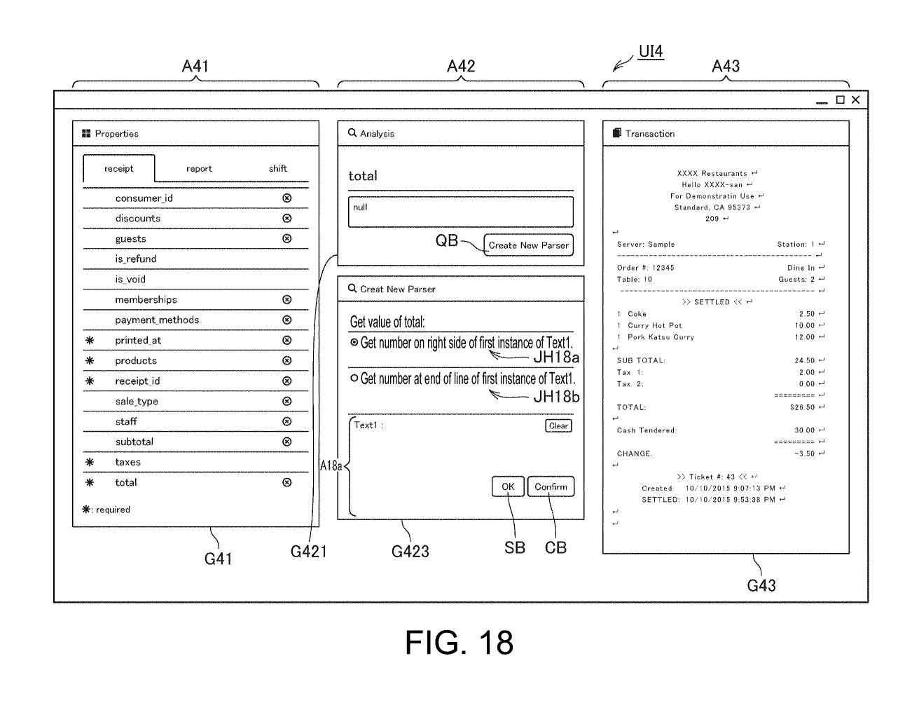

FIG. 18 shows the step correlation pane G423 that is displayed in the second area A42 instead of the frame selection pane G422 when the first total amount information frame is selected from the frame selection pane G422 in FIG. 17.

Two options are displayed in the step correlation pane G423 in FIG. 18: (1) rule information JH18a and (2) rule information JH18b. The search rule defined by rule information JH18a is that the transaction total information J92 (parameter value) is on the same line as the keyword appearing first (highest) in the printed text data, and is on the right side of the keyword. The search rule defined by rule information JH18b is that the transaction total information J92 (parameter value) is on the same line as the keyword appearing first (highest) in the printed text data, and is at the end of the line. A radio button is displayed beside each instance of rule information, which can be selected by selecting the corresponding radio button. The user defines the search rule by selecting the appropriate radio button.

By referring to the text display pane G43 displayed simultaneously with the step correlation pane G423, the user can determine the location of the transaction total information J92 relative to the keyword (transaction total identifier J91), and can select the appropriate information by selecting the search rule corresponding to rule information JH18a or the search rule corresponding to rule information JH18b.

In rule information JH18a and rule information JH18b, the keyword is represented by the string “Text1”. Below area A18b is a text field A18a where the word selected as the keyword is displayed. As described above and below, a keyword may include a combination of words (including spaces). In text field A1ba the string Text1 is displayed, showing that the word selected as the keyword is displayed.

Using the text display pane G43 in third area A43, the user can select one or more words to use as the keyword.

User operations and the process of the control server controller 40 when the fourth user interface UI4 shown in FIG. 18 is displayed, and the user selects the combination of the words “TOTAL” and “:” as the keyword. Note that the keyword TOTAL: is equivalent to the transaction total identifier J91.

A combination of multiple words may also be referred to as as a “word group.”

The user moves the cursor over the words to include in the keyword (as described above, including space characters) in the text display pane G43. as described above, the background color of the word over which the cursor hovers changes to yellow to indicate the selection candidate.

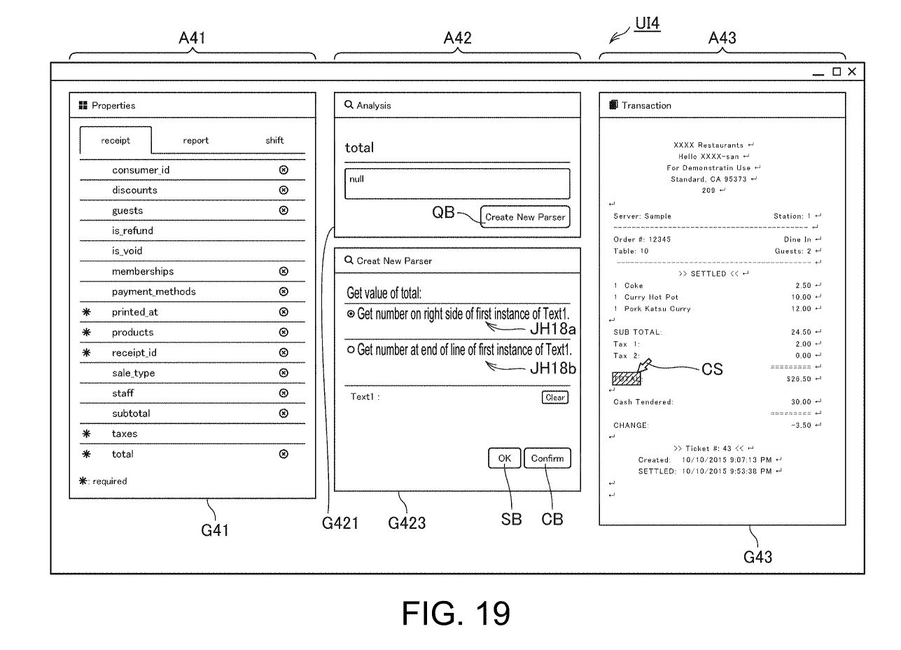

FIG. 19 shows the word TOTAL when selected as a candidate.

The user confirms the selected word by performing a specific operation (such as double clicking) when the cursor is over the desired word. When the user performs the specific operation and confirmation of the selected word is detected, the control server controller 40 displays the selected word in the text field A18a. The user can verify the selected word by referring to the text field A18a.

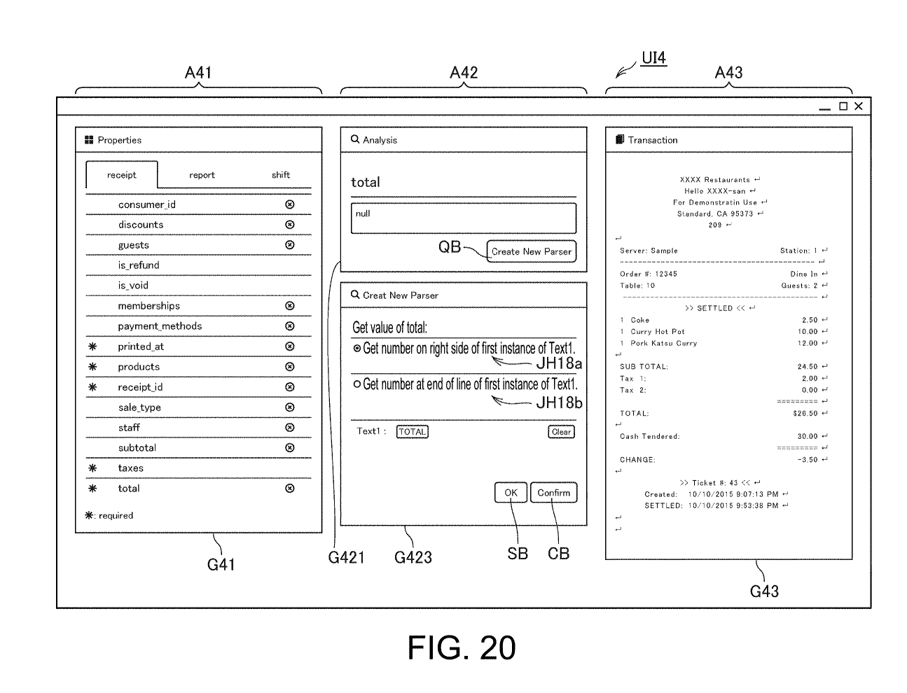

FIG. 20 shows when the selection of the word TOTAL is confirmed and the word TOTAL is displayed in the text field A18a.

After selection of the word TOTAL is confirmed, the control server controller 40 executes the following process.

Specifically, the control server controller 40 enables selecting only the words near and on the right side on the same line as the most recently confirmed word selection (TOTAL in this example), and indicates by underlining the words that can be selected. In the example in FIG. 18, the control server controller 40 enables selecting only the word “:” adjacent to the word TOTAL, and draws an underline under the word “:”.

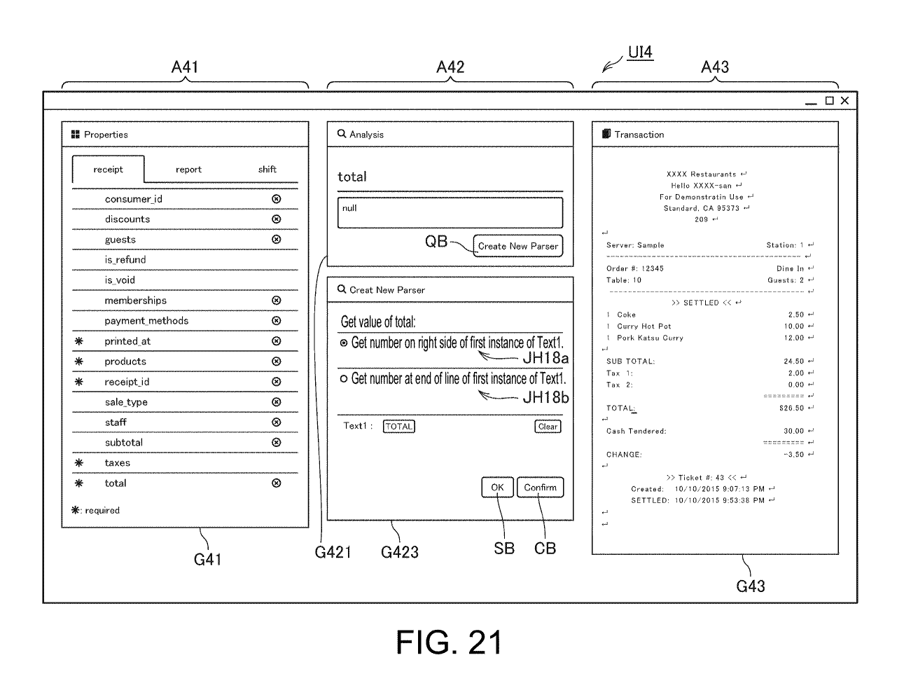

FIG. 21 shows the word “:” underlined indicating that the word “:” can be selected.

The user, by seeing the words that are underlined, can easily and directly know that the word(s) can be selected.

After seeing the word “:” underlined, the user then selects the word “:” in the same way as selecting the word TOTAL.

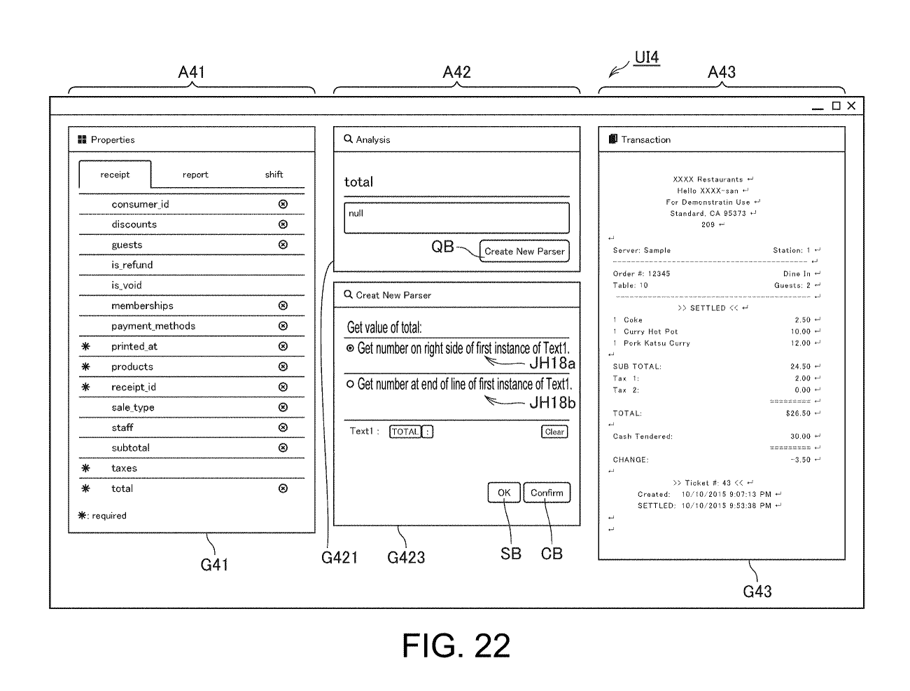

FIG. 22 shows when the selection of the word TOTAL is confirmed, the word “:” is then selected, and the word “TOTAL” and the word “:” are displayed consecutively in text field A18c.

The control server controller 40 displays the text written in the printed text data in the text display pane G43 so that words (including space characters) can be selected. The control server controller 40 then sets the words or word groups selected by the user as keywords. As a result, input errors that may be result when the user manually inputs the text (characters) in the keywords can be reliably prevented, and the user accurately select the words or word groups for the desired keywords.

When selecting a keyword, the control server controller 40 enables selecting, after the selection of one word is confirmed, only words that are beside the one word and on the right side of the one word. The effect of this is described below.

A word group that can be used as a keyword in a receipt is a combination of one or more consecutive words on one line. As a result, by the control server controller 40 executing the above process, the user, when selecting a word group as a keyword, can sequentially select consecutive words on one line. More particularly, in the tax information identifier J81 of the printed text data T2 shown in FIG. 6B, the string sales□tax is a combination of the word “sales”, a space character, and the word “tax”. When the tax information identifier J81 is selected as a keyword, the space character must also be included in the keyword, but the user may not be aware that the space character must also be included in the keyword. By the control server controller 40 executing the process described above, the user can reliably be made to select the space character as part of the keyword when a word group including a space character is selected as a keyword.

The step correlation pane G423 in FIG. 18 to FIG. 22 includes a step confirmation button (OK) SB, and a Confirm button CB.

The step confirmation button (OK) SB is a button that is operated to confirm input to the step correlation pane G423 in which the step confirmation button (OK) SB is displayed.

The Confirm button CB is displayed in the last step correlation pane G423 of the one or more step correlation panels G423 corresponding to the selected frame. The Confirm button CB can be selected in the last step correlation pane G423 in the following case. Specifically, when the information required in the last step correlation pane G423 has been selected and input, the Confirm button CB is enabled (can be selected). When the Confirm button CB in the last step correlation pane G423 is operated, all steps relevant to the selected frame have been completed and the corresponding the search rule is completed.

The Confirm button CB is a button for commanding generating a parser PS that executes a process to acquire a specific parameter value from the printed text data based on the search rule defined through all of the step correlation panels G423 corresponding to the selected frame (all steps corresponding to the selected frame).

When operation of the Confirm button CB is detected, the control server controller 40 executes the following process.

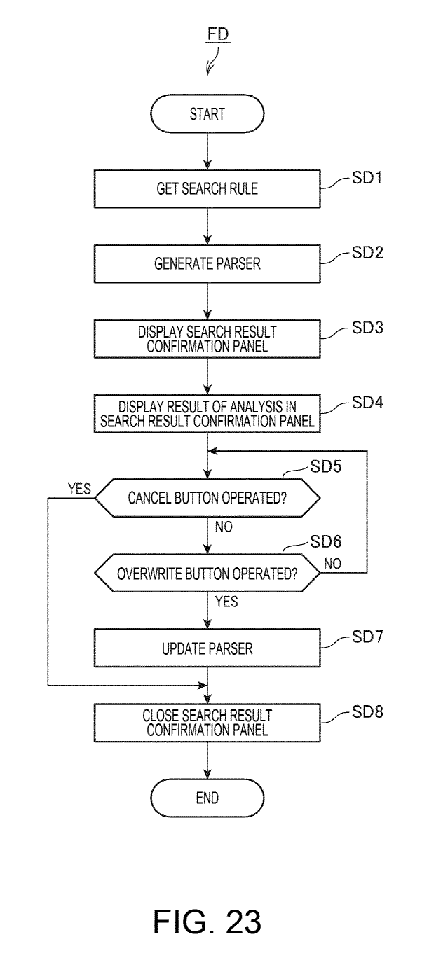

The flow chart FD in FIG. 23 is a flow chart describing the operation of the control server 15 when operation of the Confirm button CB is detected.

As shown in the flow chart FD in FIG. 23, the control server controller 40 acquires the search rule defined through all of the step correlation panels G423 related to the selected frame (step SD1).

Next, the control server controller 40 generates a parser PS for executing the process of acquiring the parameter value of the selected receipt element based on each of the acquired search rules (step SD2). Installed on the control server 15 is an engine for generating, based on the input one or more search rules, a parser PS having functions for inputting one or more search rules, and finding and acquiring a parameter value according to the one or more search rules that were input, and outputting the parser PS that was generated. In step SD2, the control server controller 40 generates the parser PS by functions of the engine.

For example, let the search rule acquired in step SD1 be the search rule corresponding to rule information JH18a. In this case, in step SD2, the control server controller 40 generates a parser PS with the ability to acquire as the parameter value the information that is on the same line as the keyword (the keyword “TOTAL:” in this example) appearing first (highest) in the printed text data, and is one position to the right of the keyword.

When searching for a parameter value based on the position of the parameter value relative to a keyword in the printed text data, the parser PS executes the following process. The parser PS first finds the location of the keyword in the printed text data by searching for the string. Note that when there are plural strings corresponding to the keyword in the printed text data, the parser PS assembles the keyword to be used to find the parameter value according to the rules of the process. Next, the parser PS determines the location of the parameter value (searches for the parameter value) based on the keyword for which the location was identified, and the relative positions of the keyword and the parameter value.

The parser PS thus determines the location of the keyword in the printed text data by means of a string search. As a result, the keyword must be the same as the string written in the printed text data. As described above, this embodiment enables the user to easily and accurately define a keyword that accurately matches the string written in the printed text data.

Next, the control server controller 40 displays a search result confirmation pane G424 in second area A42 (step SD3).

Next, the control server controller 40, by a function of the newly generated parser PS, interprets the text data to process, and displays the search result in the search result confirmation pane G424 in the second area A42 (step SD4).

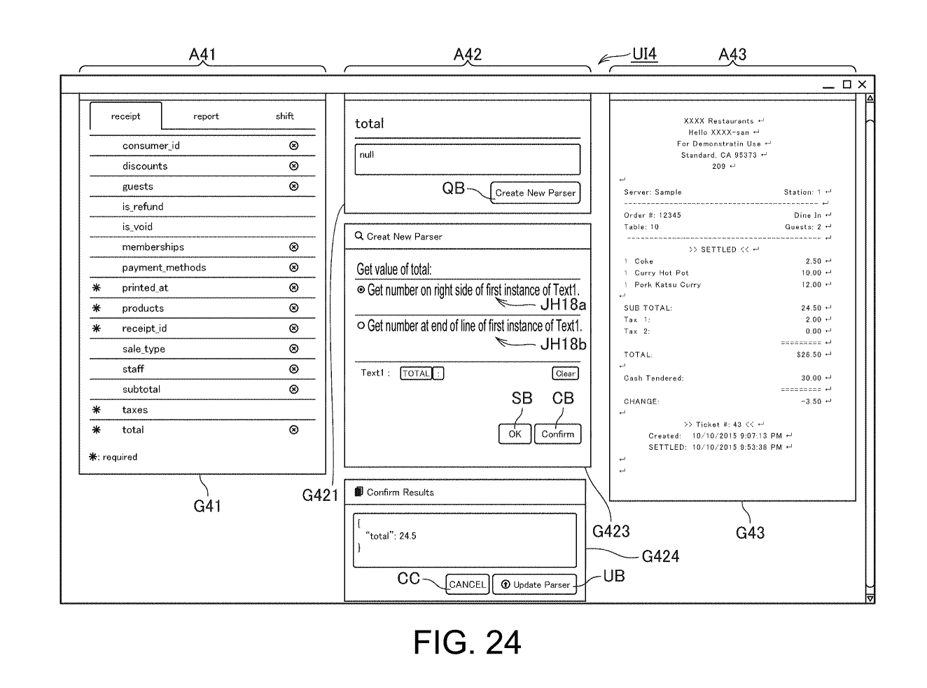

FIG. 24 shows the fourth user interface UI4 with the search result confirmation pane G424 displayed in the second area A42.

The user, by checking the content in the search result confirmation pane G424, can confirm if the result returned by the newly generated parser PS is correct (appropriate). That is, the user, referring to the text display pane G43 in the third area A43, can know the parameter value that the parser PS should acquire, and based thereon can determine if the result of the newly generated parser PS is correct (appropriate). If the correct parameter value is displayed in the search result confirmation pane G424, the user determines the result of the parser PS is correct. If a parameter value other than the correct value is displayed, the user determines the result of the parser PS is wrong (not correct).

As shown in FIG. 24, the search result confirmation pane G424 has an Update Parser button UB instructing applying the newly generated parser PS, and a Cancel button CC for cancelling applying the newly generated parser PS. If based on the content in the search result confirmation pane G424 the user determines the result of the newly generated parser PS is correct, the user operates the Update Parser button UB; otherwise, the user operates the Cancel button CC.

As shown in flow chart FC in FIG. 23, after displaying the search result of the newly generated parser PS in the search result confirmation pane G424, the control server controller 40 monitors operation of the Cancel button CC (step SD5), and operation of the Update Parser button UB (step SD6).

If operation of the Update Parser button UB is detected (step SD6: YES), the control server controller 40 executes the following process (step SD7). That is, in step SD7, the control server controller 40 references the parser management database 421, and overwrites the parser PS corresponding to the selected receipt element related to the serial number J11 of the selected printer in the database with the newly generated parser PS.

As a result of step SD7, the control server controller 40, when printed text data is received from the selected printer, executes the process of acquiring the parameter value for the selected receipt element based on the function of the newly generated parser PS.

Next, the control server controller 40 closes the search result confirmation pane G424 (step SD8).

However, if the Cancel button CC was operated (step SD5: YES), the control server controller 40 does not update the parser management database 421, goes to step SD8, and closes the search result confirmation pane G424.

Note that when a record is first created for one printer 12 in the parser management database 421, the parsers PS related to the serial number J11 of the one printer 12 are predefined default parsers PS.

### Second Total Amount Information Frame

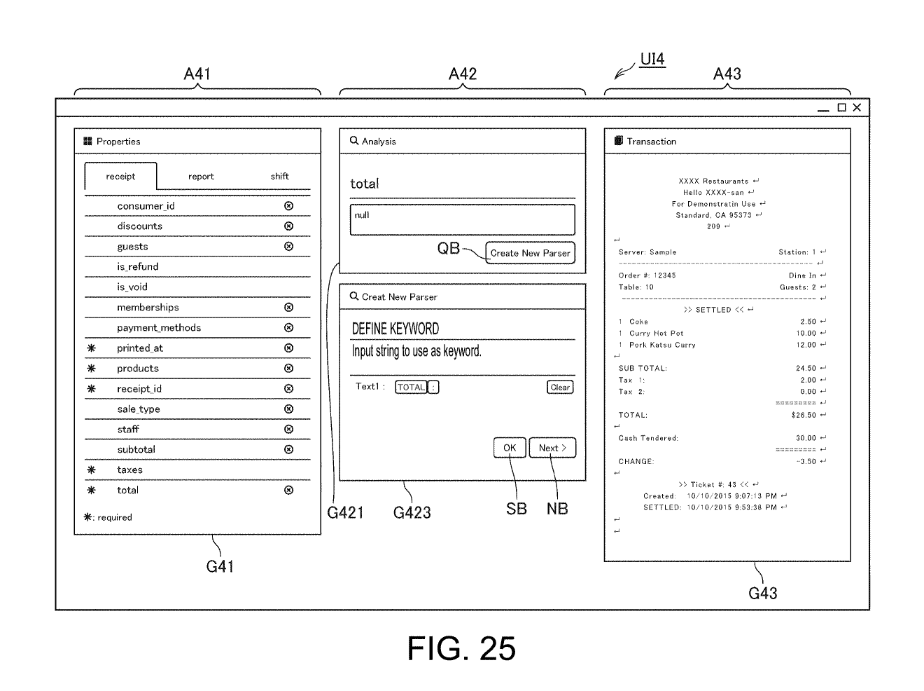

FIG. 25 shows the step correlation pane G423 that is displayed instead of the frame selection pane G422 when the second total amount information frame is selected from the frame selection pane G422 in FIG. 17. The second total amount information frame contains multiple steps.

In the step correlation pane G423 in FIG. 25, the keyword used to find the parameter value (transaction total information J92 in this example) of the selected receipt element (total amount parameter in this example) can be input. Using the text display pane G43 and the method described above, the user selects the words or word groups to use as the keyword. As a result, the user can define a search rule that the keyword is a specific word or word group.

The step correlation pane G423 in FIG. 25 is the step correlation pane G423 that is displayed next. As a result, the Confirm button CB is not displayed in the step correlation pane G423 in FIG. 25, but a Next button NB for going to the next step correlation pane G423 is displayed.

When operation of the Next button NB is detected, the control server controller 40 goes to the next step correlation pane G423.

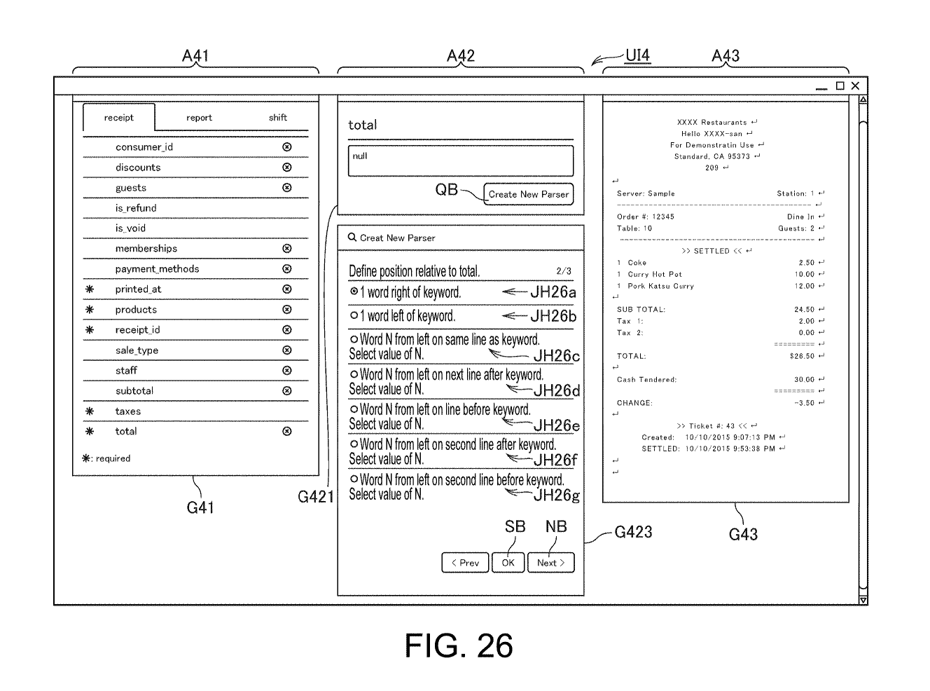

FIG. 26 shows an example of the step correlation pane G423 displayed in place of the step correlation pane G423 in FIG. 25 when the Next button NB in the step correlation pane G423 in FIG. 25 is operated.

The step correlation pane G423 in FIG. 26 displays seven options, rule information JH26a to rule information JH26g, for defining a search rule based on the relative positions between the keyword and corresponding parameter value. The user, referring to the text display pane G43, selects from among rule information JH26a to rule information JH26g the rule information corresponding to the appropriate search rule.

Of rule information JH26a to rule information JH26g, rule information JH26c is described below.

Rule information JH26c states that the parameter value corresponding to the selected receipt element is on the same line as the keyword, and is word N (where N is an integer) from the left end of the line. That a word is word N on a line means the following. That is, word N on a line means that the word is the Nth word from the left end when counting the words from the left end of the line, not including spaces. For example, on line 4 in the printed text data T2 in FIG. 6B, not including spaces, the words are the word Beer, the word 1, and the word 10.00. As a result, the word Beer is word 1, the word 1 is word 2, and the word 10.00 is word 3. The word 10.00 is also the last word on line 4 in printed text data T2.

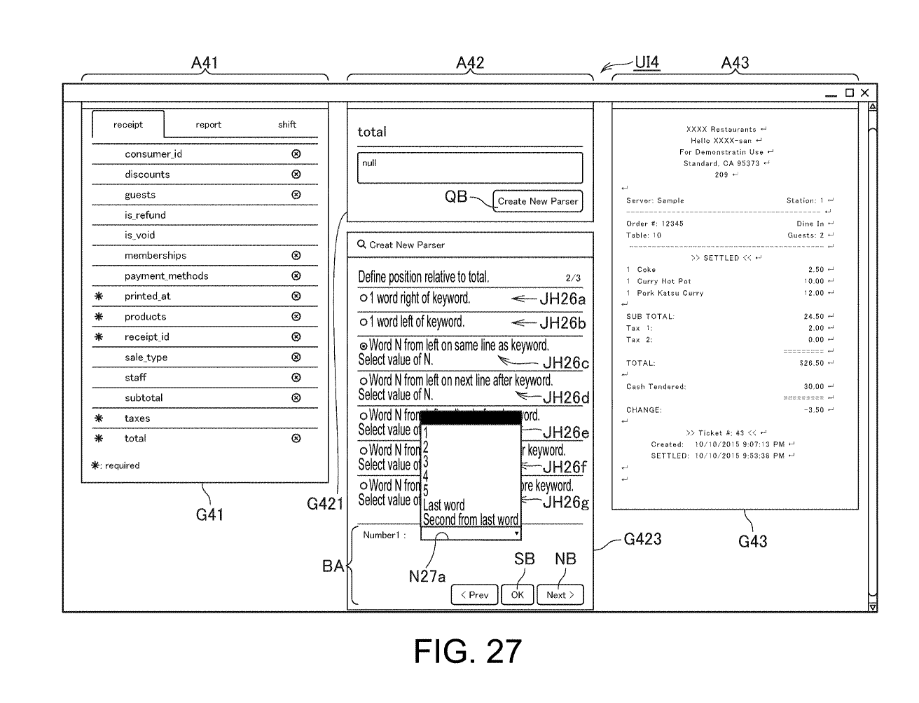

FIG. 27 shows an example of the step correlation pane G423 displayed when rule information JH26c is selected by the corresponding radio button in the step correlation pane G423 in FIG. 26.

As shown in FIG. 27, when rule information JH26c is selected, a number display area BA is formed at the bottom of the step correlation pane G423. The number display area BA is an area where, when the search rule selected by the user is that information (word) N is required, the user is prompted to select the value of N, and the value of N selected by the user is displayed. In FIG. 27, the value of the displayed numbers that can be selected in the number display area BA may be made to correspond to the number of words on the line.

In this way, the control server controller 40 forms a number display area BA that prompts the user to select the value of N, and displays the value of N selected by the user, when the search rule selected by the user is that information (word) N is required.

As shown in FIG. 27, number display area BA has an input field N27a. The input field N27a enables inputting the value of N by selecting the N value from a pull-down menu. The user, by selecting the desired value from the pull-down menu in the input field N27a, inputs the value of N to the input field N27a.

As shown in FIG. 27, in this example the user can select, as the value of N, one of the numbers 1 to 5, last, or second from last. This is based on the possibility that the specific parameter value is the last, or second from last, value on the specific line.

Based on the possibility that a specific parameter value may be written in the printed text data based on a rule that the value is Nth value on the specific line, this embodiment enables the user to easily and directly define a correspondingly appropriate search rule. In the step correlation pane G423 in FIG. 27, the user selects one search rule from the search rules corresponding to the seven options rule information JH26a to rule information JH26g, then selects, as necessary, the value of N using the number display area BA, then operates the Next button NB to confirm the search rule setting. When operation of the Next button NB is detected, the control server controller 40 goes to the next step correlation pane G423.

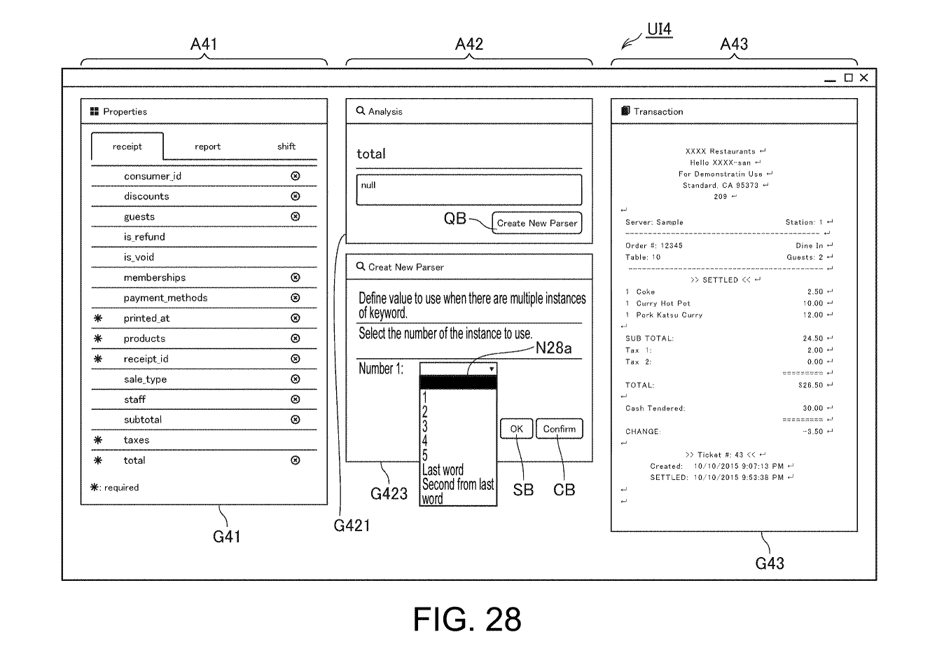

FIG. 28 shows an example of the step correlation pane G423 that is displayed in place of step correlation pane G423 in FIG. 27 when the search rule corresponding to rule information JH26c is selected in step correlation pane G423 in FIG. 27, “Last” is selected as the value of N, and the Next button NB is then operated.

When plural instances of the keyword defined by the user are written in the printed text data, the step correlation pane G423 in FIG. 28 is a pane for defining a search rule which instance N of the keyword to use to search for the parameter value in the printed text data.

In this example there are plural instances of a string that may be used as a keyword. For example, when the word TOTAL is used as a keyword, the string TOTAL may be found in the subtotal identifier J71 and the transaction total identifier J91, and the string TOTAL may therefore be printed more than once in the printed text data. Even in this event, because the string used as the keyword is printed according to a rule corresponding to the layout of the receipt, the desired instance of the keyword can be defined by specifying that the keyword is the Nth instance of the word.

As shown in FIG. 28, the step correlation pane G423 has an input field N28a. The input field N28a enables inputting the value of N by selecting the value of N from a pull-down menu. The user, by selecting the desired value from the pull-down menu in the input field N28a, inputs the value of N to the input field N28a.

As shown in FIG. 28, in this example the user can select, as the value of N, one of the numbers 1 to 5, last, or second from last. This is based on the possibility that the location of the specific keyword may be the last, or second from last, instance. In FIG. 28, the value of the displayed numbers that can be selected in the number display area BA may be made to correspond to the number of instances of the keyword in the printed text data.

The step correlation pane G423 shown in FIG. 28 is the last step correlation pane G423 that may be displayed for the selected frame (in this example, the second total amount information frame). In the step correlation pane G423 in FIG. 28, the user uses a pull-down menu to select and input the value of N to the input field N28a. After inputting to the input field N28a, the user operates the step confirmation button (OK) SB or Confirm button CB. The operation of the control server controller 40 when one of these buttons is operated is as described above.

As described in this example, a string specified as the keyword may be written multiple times in the printed text data according to the rules of the specific receipt layout, and this embodiment enables the user to easily and directly define a correspondingly appropriate search rule.

### Parser 5 PS5

Generating parser 5 PS5 is described next.

To generate parser 5 PS5, the user selects from the element selection group G41 the void parameter (is_void property).

The is_void property (void parameter) is data type: boolean, and thus differs from the total property (total amount parameter).

As described above, a transaction may be cancelled, in which case information indicating that the transaction was cancelled (voided; referred to below as void information J28) is written in the printed text data based on the receipt produced in the transaction. When the void information J28 is written in the printed text data, the parameter value of the void parameter is true; when void information J28 is not written in the printed text data, the parameter value of the void parameter is false.

The control server controller 40 executes the process described below to generate a parser PS with the ability to find a receipt element corresponding to a property of data type: boolean, which takes a value of true or false according to whether or not specific information is written in the printed text data.

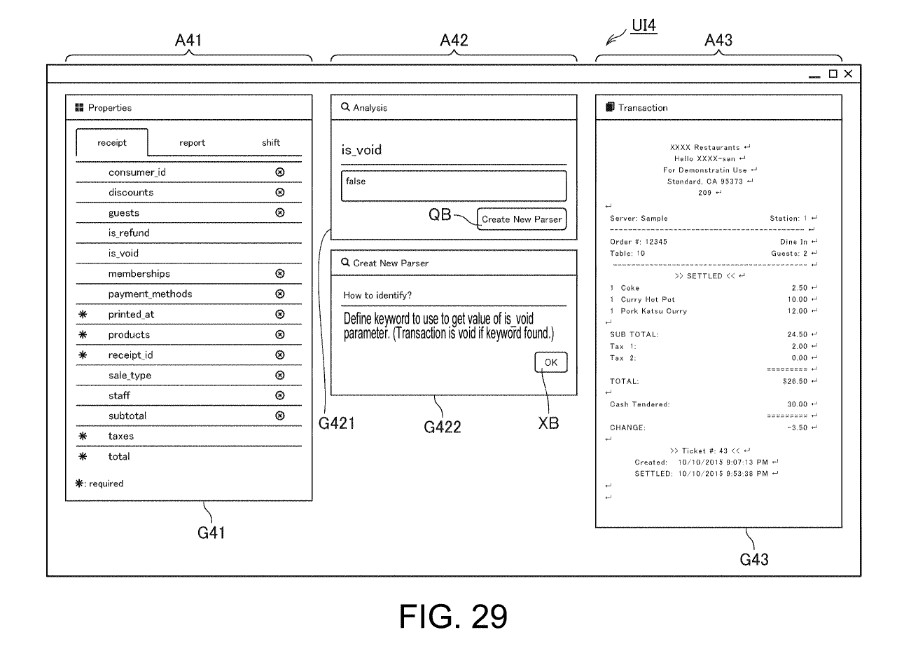

FIG. 29 shows an example of the frame selection pane G422 displayed in second area A42 when the void parameter is selected in element selection group G41, and the Create New Parser button QB is operated in the acquired parameter value display pane G421 related to the void parameter.

The void parameter has one corresponding rule frame. The user confirms selection of the frame by operating the frame confirmation button XB displayed in the frame selection pane G422 for the void parameter. When operation of the frame confirmation button XB is detected, the control server controller 40 changes the frame selection pane G422 to the step correlation pane G423.

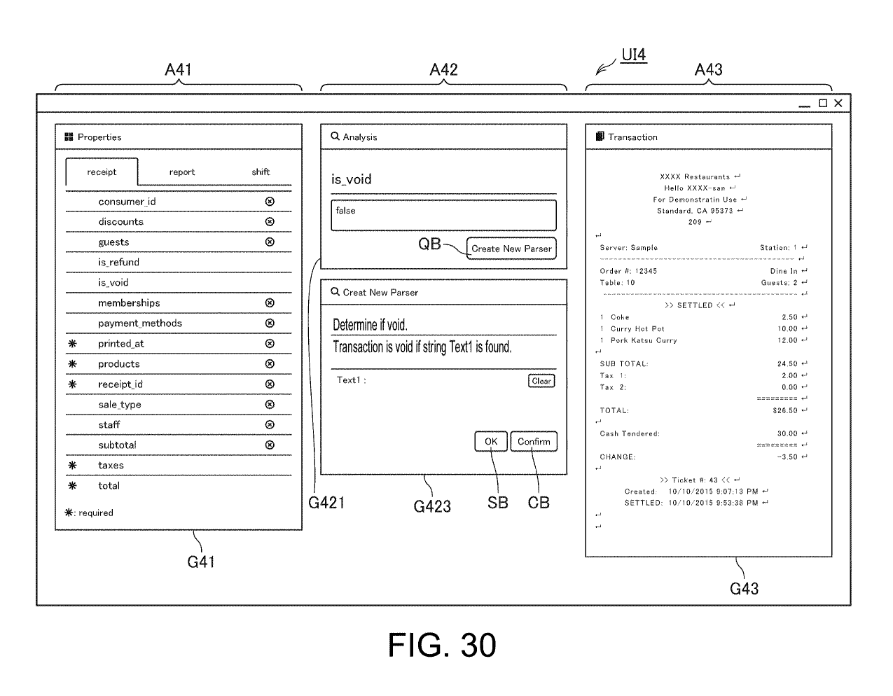

FIG. 30 shows the step correlation pane G423 that replaces the frame selection pane G422 in FIG. 29. The frame related to the void parameter has one step.

The keyword used to acquire the parameter value of the selected receipt element (the void parameter in this example) can be input in the step correlation pane G423 in FIG. 30. In the case of the void parameter, the keyword is void information J28.

Using the step correlation pane G423 in FIG. 30, the user can define a search rule that the keyword is a specific word or word group.

When the void information J28 is written in text in text display pane G43 as the text data to process, the user selects the word or word group to use as the keyword by the method described above.

When the void information J28 is not written in text in text display pane G43 as the text data to process, the user defines the search rule by the method described below. When a transaction is cancelled (voided), the user acquires the void information J28 printed on the receipt and inputs a string representing the void information J28 using a keyboard or other input device.

The keyword input by the user is displayed in a specific area of the step correlation pane G423.

After input the keyword to the step correlation pane G423 shown in FIG. 30, the user operates step confirmation button (OK) SB or Confirm button CB. The process then executed by the control server controller 40 when one of these buttons is operated is as described above.

This embodiment enables the user to easily and directly generate a parser PS able to acquire the parameter value of a receipt element corresponding to a property of data type: boolean.

### Parser 9 PS9

Generating a parser 9 PS9 is described next.

To generate a parser 9 PS9, the user selects the product information parameter (products property) from the element selection group G41.

As described above, the product information parameter has a product name element, purchased quantity element, and a unit price element.

The parser 9 PS9 is a parser PS with functions for executing a process to acquire the parameter values of the purchased quantity element, product name element, and unit price element.

When writing information to the printed text data, the purchased quantity information J61 (parameter value of the purchased quantity element), product name information J62 (parameter value of the product information parameter), and price information J63 (parameter value of the unit price element) have the following characteristics.

The purchased quantity information J61, product name information J62, and price information J63 may be written to the printed text data with no relationship to other specific information. As a result, the location of this information cannot be identified based on the relationship to a certain keyword.

The purchased quantity information J61, product name information J62, and price information J63 for one type of product may also be printed on the same line regardless of the layout of the receipt. This is because this information is essential information that must be printed on each receipt, and by printing the information on the same line, the information is known to be information related to a product of one type (a specific product). Furthermore, when multiple instances (multiple lines) of product information J6 are printed on the receipt, printing the information on one line makes the correlation between the purchased quantity information J61, product name information J62, and price information J63 to one product obvious.

Another feature is that product information J6 including purchased quantity information J61, product name information J62, and price information J63 is printed on the receipt in an area between one specific string and another specific string. In this case, this information is written in the printed text data in an area between one specific string and another specific string.

Based on these features, the control server controller 40 executes the process described below when creating parser 9 PS9.

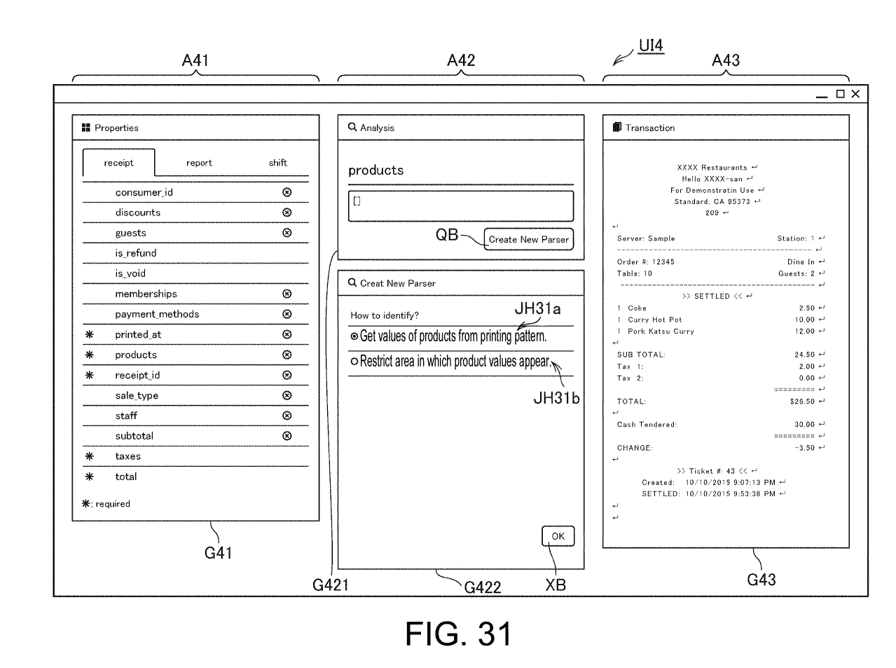

FIG. 31 shows an example of the frame selection pane G422 displayed in second area A42 when the product information parameter is selected in element selection group G41, and the Create New Parser button QB is operated in the acquired parameter value display pane G421 related to the product information parameter.

The number of frames corresponding to the product information parameter is two, a first product information frame and a second product information frame. In the frame selection pane G422 in FIG. 31 is displayed a list of frame information JH31a describing the first product information frame, and frame information JH31b describing the second product information frame. A radio button is displayed for each frame information instance, and the desired frame can be selected using the corresponding radio button.

The first product information frame is a frame corresponding to a search rule for defining the location of the purchased quantity information J61, product name information J62, and price information J63 in the printed text data based on the order of the information in one line (the order the information appears on one line).

The second product information frame is a frame corresponding to a search rule for defining the location of the purchased quantity information J61, product name information J62, and price information J63 in the printed text data based on the order of the information in one line and the areas where the information is written.

After selecting a frame with a radio button, the user operates the frame confirmation button XB displayed in the frame selection pane G422 of the product information parameter to confirm the frame selection. When operation of the frame confirmation button XB is detected, the control server controller 40 changes the frame selection pane G422 to the step correlation pane G423.

When the selected frame is the first product information frame, and when the selected frame is the second product information frame, are described in order below.

### First Product Information Frame

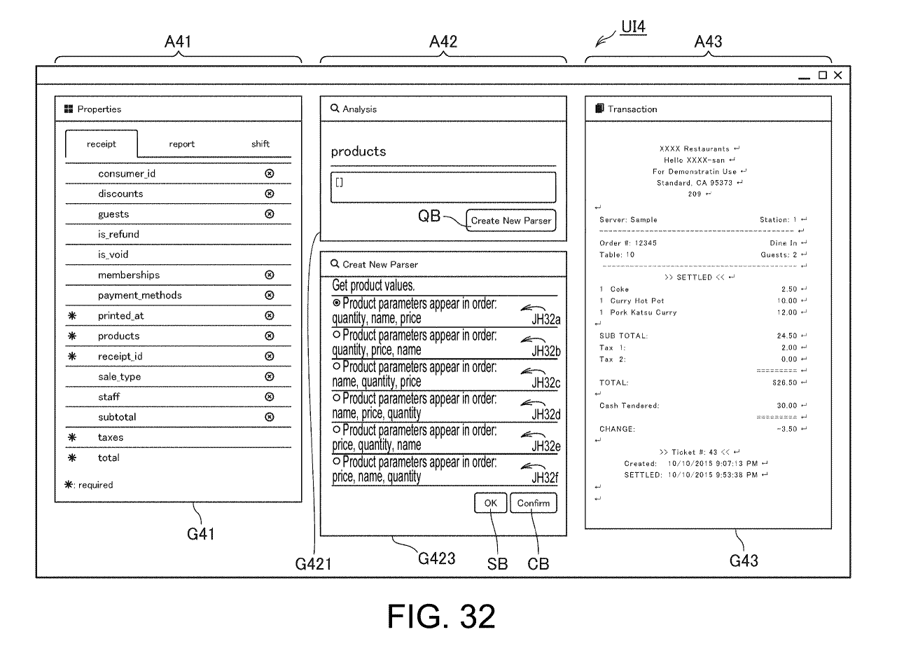

FIG. 32 shows the step correlation pane G423 that replaces the frame selection pane G422 in FIG. 31 when the first product information frame is selected. The first product information frame has one step.

When the purchased quantity information J61, product name information J62, price information J63 are printed on one line, the order of the information from left to right will be in one of the six patterns described below.

Pattern 1: purchased quantity information J61, product name information J62, price information J63

Pattern 2: purchased quantity information J61, price information J63, product name information J62

Pattern 3: product name information J62, purchased quantity information J61, price information J63

Pattern 4: product name information J62, price information J63, purchased quantity information J61

Pattern 5: price information J63, purchased quantity information J61, product name information J62

Pattern 6: price information J63, product name information J62, purchased quantity information J61

Based thereon, the step correlation pane G423 in FIG. 32 displays a list of rules describing the order of the purchased quantity information J61, product name information J62, price information J63: rule information JH32a defining a search rule specifying printing the information in pattern 1; rule information JH32b defining a search rule specifying printing the information in pattern 2; rule information JH32c defining a search rule specifying printing the information in pattern 3; rule information JH32d defining a search rule specifying printing the information in pattern 4; rule information JH32e defining a search rule specifying printing the information in pattern 5; and rule information JH32f defining a search rule specifying printing the information in pattern 6. A radio button is displayed for each rule, and the desired rule information can be selected by selecting the corresponding radio button. The user specifies the desired search rule by selecting the corresponding rule information.

After selecting the desired search rule in the step correlation pane G423 in FIG. 32, the user operates step confirmation button (OK) SB or Confirm button CB. The processes executed by the control server controller 40 when one of these buttons is operated are as described above.

More specifically, the control server controller 40 acquires all search rules corresponding to the frame selected in the step correlation pane G423. Next, the control server controller 40, based on the acquired search rules, generates a parser PS (parser 9 PS9 in this example) that executes a process acquiring the parameter values of the selected receipt elements. A specific example of a method whereby the parser 9 PS9 acquires the parameter values based on the pattern in which the information appears on one line is described below.

The function of parser 9 PS9 related to the first product information frame is described next using as an example executing the process based on the search rules related to pattern 1.

The string representing the purchased quantity information J61 has the following features. That is, the characters in the string representing the purchased quantity information J61 include numeric characters and a special character, and other characters are not used. The special character used in the string representing the purchased quantity information J61 is generally a character such as “@” that is used to denote a quantity per unit. The information expressed by a string comprising such characters is referred to below as “quantitative information.”

The string representing the price information J63 has the following features. That is, the characters in the string representing the price information J63 include numeric characters, a character representing a decimal point, currency symbols (such as “¥”, “$”), the plus sign (+) and minus sign (−), and other characters are not used. The information expressed by a string comprising such characters is referred to below as “numeric information.”

Below, information that is not quantitative information and is not numeric information is referred to as “discretionary information.”

As a result, when pattern 1 is applied, information written on the line on which the purchased quantity information J61, product name information J62, and price information J63 are written is written in the following format. That is, there are three information objects, and the objects are written from left to right in the order: quantitative information, discretionary information, numeric information.

Based thereon, parser 9 PS9 identifies, in the text data to process, the one or more lines that contain three information objects with the objects arranged from left to right in the order quantitative information, discretionary information, numeric information. Next, in each identified line, parser 9 PS9 identifies the object at the beginning of the line as the purchased quantity information J61 (quantitative information), the next object as product name information J62 (discretionary information), and the next object as the price information J63 (numeric information).

The first product information frame is valid when there are no lines in which quantitative information, discretionary information, and numeric information are present in the specified order other than the lines containing the purchased quantity information J61, product name information J62, and price information J63.

### Second Product Information Frame

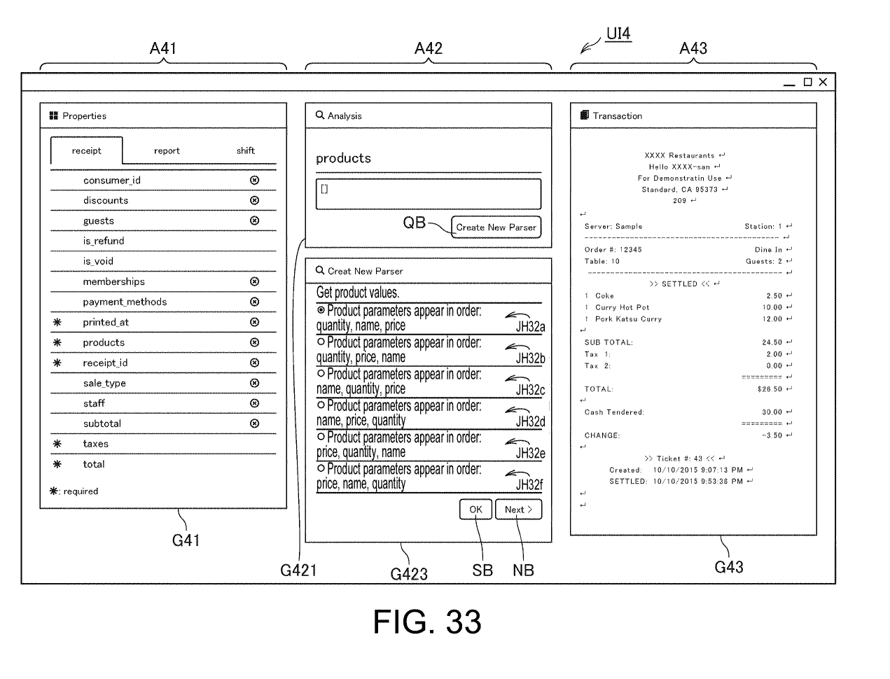

FIG. 33 shows the step correlation pane G423 that replaces the frame selection pane G422 in FIG. 31 when the second product information frame is selected.

Rule information JH32a to rule information JH32f described above are also listed in the step correlation pane G423 in FIG. 33. A radio button is displayed for each rule, and the desired rule information can be selected by selecting the corresponding radio button. The user specifies the desired search rule by selecting the corresponding rule information.

After selecting the search rule in the step correlation pane G423 in FIG. 33, the user operates the Next button NB. When operation of the Next button NB is detected, the control server controller 40 changes the step correlation pane G423 in FIG. 33 to the next step correlation pane G423.

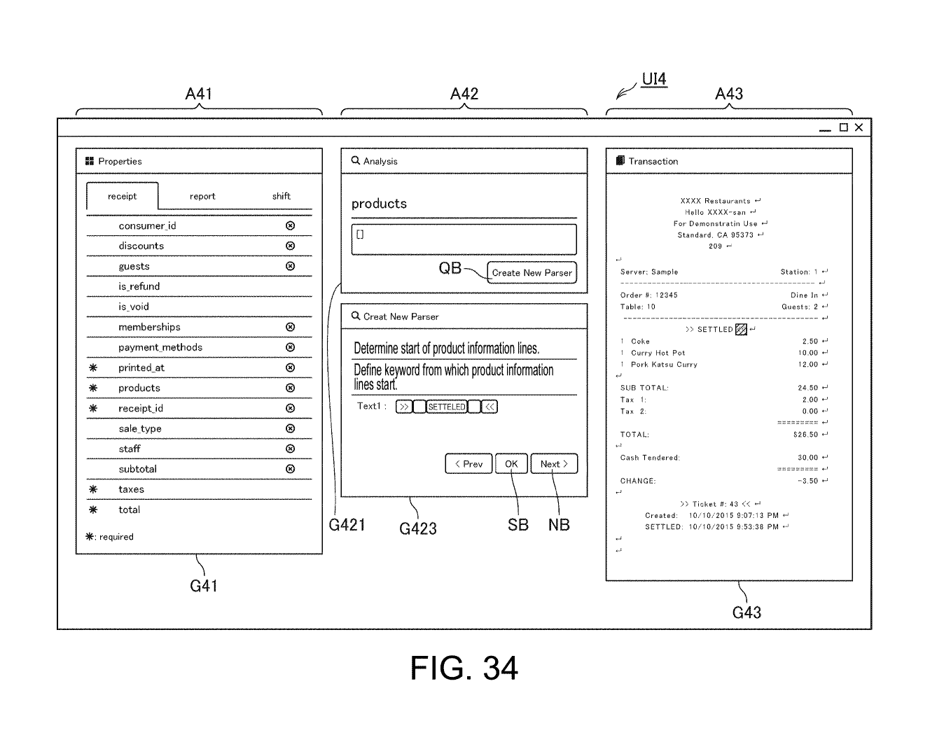

FIG. 34 shows an example of the step correlation pane G423 displayed in place of the step correlation pane G423 in FIG. 33 when the Next button NB in the step correlation pane G423 in FIG. 33 is operated.

As described above, the product information J6 may be written in the printed text data according to a rule that the product information J6 is written to an area between one specific string and another specific string. Of the specific strings defining the area where the product information J6 is written, the string located at the top is referred to as the “area-starting string,” and the string located at the bottom is referred to as the “area-ending string.” The area-starting string can be input to the step correlation pane G423 in FIG. 34.

Using the step correlation pane G423 in FIG. 34, the user can define a search rule specifying the specific word or word group in the area-starting string.

Using text based on the text data to process displayed in the text display pane G43, the user can select the word or word group to use as the keyword by the method described above.

The word or word group of the area-starting string input by the user is displayed in a specific area of the step correlation pane G423. FIG. 34 shows the word group related to the area-starting string displayed in a specific area of the step correlation pane G423.

After inputting the area-starting string in the step correlation pane G423 in FIG. 34, the user operates the Next button NB. When operation of the Next button NB is detected, the control server controller 40 changes the step correlation pane G423 in FIG. 34 to the next step correlation pane G423.

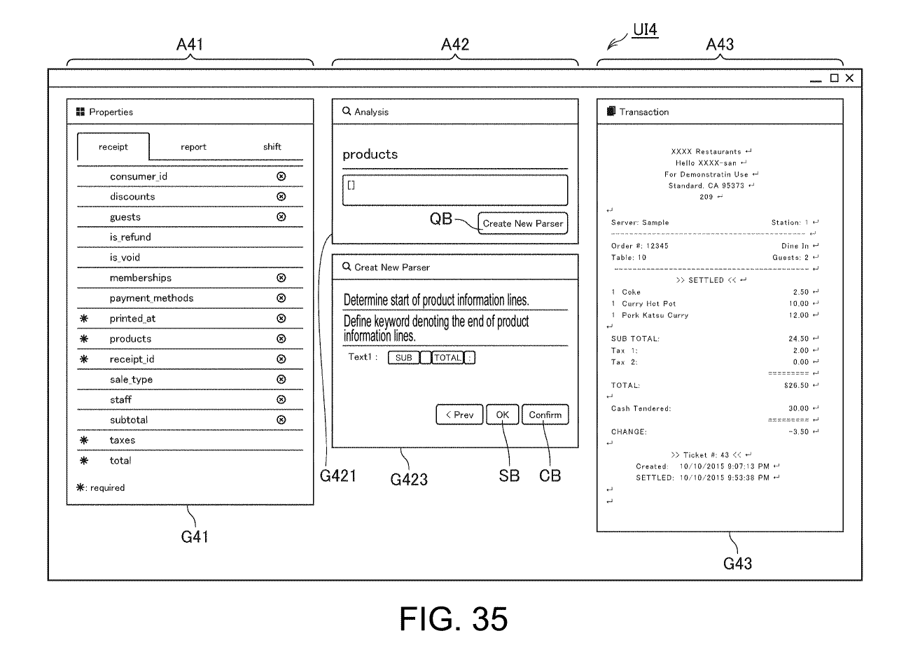

FIG. 35 shows an example of the step correlation pane G423 displayed in place of the step correlation pane G423 in FIG. 34 when the Next button NB in the step correlation pane G423 in FIG. 34 is operated.

The area-ending string can be input to the step correlation pane G423 in FIG. 35.

Using the step correlation pane G423 in FIG. 35, the user can define a search rule specifying the specific word or word group in the area-ending string.

Using text based on the text data to process displayed in the text display pane G43, the user can select the word or word group to use as the keyword by the method described above.

The word or word group of the area-ending string input by the user is displayed in a specific area of the step correlation pane G423. FIG. 35 shows the word or word group related to the area-ending string displayed in a specific area of the step correlation pane G423.

After inputting the keyword in the step correlation pane G423 in FIG. 35, the user operates step confirmation button (OK) SB or Confirm button CB. The processes executed by the control server controller 40 when one of these buttons is operated are as described above.

To find the purchased quantity information J61, product name information J62, price information J63, parser 9 PS9 related to the second product information frame first finds the area delimited by the area-starting string and area-ending string. Next, parser 9 PS9, by the method described above, identifies the locations of the desired information within the identified area. For example, when executing a process based on a search rule related to pattern 1, the control server controller 40 executes the following process.

By a function of parser 9 PS9, the control server controller 40 identifies, in the identified area, the one or more lines in the text data to process that contain three information objects with the objects arranged from left to right in the order quantitative information, discretionary information, numeric information. Next, in each identified line, parser 9 PS9 identifies the object at the beginning of the line as the purchased quantity information J61 (quantitative information), the next object as product name information J62 (discretionary information), and the next object as the price information J63 (numeric information).

As described above, the control server controller 40 (controller) in this embodiment acquires information printed on a print medium as printed text data (text data) written in text, parses the text in the acquired printed text data into words and displays the words in a selectable manner, and then analyzes the printed text data based on the one or more selected words.

Thus, the user can input keywords required to create a parser PS, and easily create a parser PS, by the simple operation of selecting one or more words while looking at text based on the printed text data. In other words, the job of the user is simplified when analyzing printed text data by a control server 15.

In this embodiment, text is arranged in the printed text data according to the layout in which the information is printed on the print medium, and the control server controller 40 displays the individual words parsed (deconstructed) from the text according to the layout.

As a result, the user can easily and directly know the content and the layout of the information in the printed text data, and can appropriately select one or more words to use as a keyword.

In this embodiment, the control server controller 40 also applies specific styling to the displayed words that are candidates for selection.

Thus, the user can easily and correctly know what words are selection candidates, and can easily select the words that can form a correct keyword.

In addition, when one word is selected, the control server controller 40 in this embodiment enables selecting words that are on the same line as the one word and are consecutive to the one word as keywords.

Thus, when selecting multiple words as keywords, the user can unmistakably select the words that can be used as keywords from among the consecutive words that can be selected on the same line.

A printer 12 for printing receipts is also connected to the control server 15 in this embodiment. The control server controller 40 acquires printed text data in which information printed on the receipt is written as text.

Thus, the control server 15 enables the user, by a simple operation, to create a program (parser PS) for analyzing information printed on a receipt. In other words, the job of the user is simplified when using the control server 15 to analyze printed text data corresponding to a particular receipt.

As described above, the control server controller 40 (controller) in this embodiment acquires printed text data (text data) comprising, written as text, information including the parameter values of plural elements printed on the print medium, and displays a first area A41 (first area) enabling selecting the plural elements; and a second area A42 enabling defining a rule used to acquire from the printed text data the parameter value corresponding to the element selected in the first area A41; analyzes the printed text data based on the rule defined in the second area A42; and acquires the parameter value corresponding to the analyzed element.

Thus, a parser PS can be generated by the simple operation of selecting an element in the first area A41, and defining a rule appropriate to the selected element in the second area. As a result, the job of the user required to analyze printed text data with the control server 15 is simplified.

The control server controller 40 in this embodiment also displays in the first area A41 a mark M4a (first additional information) flagging each element for which acquiring the parameter value must be enabled when executing a process to acquire parameter values according to rules corresponding to specific elements.

This configuration enables the user to correctly know the elements for which acquiring the parameter value must be enabled.

The control server controller 40 in this embodiment also displays in the first area A41 a mark M4b (second additional information) flagging each element for which acquiring the parameter value cannot be acquired when executing a process to acquire parameter values based on rules corresponding to specific elements.

This configuration enables the user to correctly know the elements for which acquiring the parameter value cannot be acquired at that time.

A fourth user interface UI4 according to this embodiment also has a third area A43 in which text based on the printed text data is displayed.

This configuration enables the user to correctly input to the second area A42 while viewing text based on the printed text data.

Furthermore, in this example, text is arranged in the printed text data according to the layout in which the information is printed on the print medium, and the control server controller 40 displays, in the third area A43, text based on the printed text data in a format corresponding to the receipt.

This configuration enables the user to easily and directly know the content and layout of the information written in the printed text data.

A printer 12 for printing receipts is also connected to the control server 15 in this embodiment. The control server controller 40 acquires printed text data in which information printed on the receipt is written as text.

Thus, the user, by a simple operation, can create a program (parser PS) for analyzing information printed on a receipt. In other words, the job of the user is simplified when using the control server 15 to analyze printed text data corresponding to a particular receipt.

In this embodiment, the parameter values that are objects to be acquired by the parser PS include information (subtotal information J72) related to the subtotal in the transaction for which a receipt was produced, information related to the total (transaction total information J92), or information related to the products purchased (product information J6) in the transaction.

This configuration enables the user, by a simple operation, to create a program (parser PS) for executing a process that acquires the subtotal information J72, transaction total information J92, and product information J6 printed on a receipt.

As described above, when creating a program that acquires text data containing information written as text including the parameter values of multiple elements printed on a print medium, causes selection of one element from the group of plural elements, and acquires the parameter value corresponding to the selected element from the text data, the control server controller 40 (controller) in this embodiment displays a window enabling specifying the rule to use, and creates the program based on the rule defined in the window.

This configuration enables the user to create a parser PS by the simple operation of inputting information to the step correlation pane G423.

The control server controller 40 in this example displays a step correlation pane G423 appropriate to a selected element and causing selection of a frame (type of rule) used when executing a process acquiring the parameter value of the selected element; and based on the selected frame, causing inputting information for specifying a rule corresponding to the selected element.

This configuration enables the user to create a parser PS appropriate to the frame by the simple operation of inputting information to the step correlation pane G423 corresponding to the frame.

When plural rules are used when executing the process of acquiring the parameter value of the selected element, the control server controller 40 in this example sequentially displays a step correlation pane G423 for inputting the information defining each rule, and based on the information input to each of the step correlation panels G423, acquires the plural rules and generates a parser PS based on the plural acquired rules.

This configuration enables the user to create, by the simple operation of sequentially inputting information to the step correlation panels G423, a parser PS that executes a process acquiring parameter values based on plural rules.

The step correlation pane G423 in this example has a Confirm button CB (specific button). When operation of the Confirm button CB is detected, the control server controller 40 creates a parser PS based on the information input to the step correlation pane G423, analyzes the printed text data by functions of the generated parser PS, and displays the result.

This configuration enables the user, by checking the displayed result, to determine if the accurately determine if the result from the generated parser PS is correct.

A printer 12 for printing receipts is also connected to the control server 15 in this embodiment. The control server controller 40 acquires printed text data in which information printed on a receipt is written as text.

Thus, the user can, by a simple operation, create a program (parser PS) for analyzing information printed on a receipt.

In this embodiment, the parameter values that are objects to be acquired by the parser PS include information (subtotal information J72) related to the subtotal in the transaction for which a receipt was produced, information related to the total (transaction total information J92), or information related to the products purchased (product information J6) in the transaction.

This configuration enables the user, by a simple operation, to create a program (parser PS) for executing a process that acquires the subtotal information J72, transaction total information J92, and product information J6 printed on a receipt.

Exemplary embodiments of the invention are described above, but the invention is not limited thereto and can be modified and adapted in many ways without departing from the scope of the accompanying claims.

When the control method of the control server 15 described above (control method of an information processing device) is executed by a computer of the control server 15, or by an external device connected to the control server 15, one embodiment of the invention is directed to a program executed by a computer to implement the foregoing method, a storage medium recording the program readably by the computer, or a communication medium able to transfer the program. The recording medium may be a magnetic or optical recording medium, or a semiconductor memory device, for example. More specifically, the recording medium may be a floppy disk, HDD (Hard Disk Drive), CD-ROM (Compact Disk Read Only Memory), DVD (Digital Versatile Disk), Blu-ray(R) Disc, magneto-optical disc, flash memory device, card media, or other type of removable or fixed recording medium. The recording medium may also be an internal storage device of the control server 15 or an external device connected to the control server 15, such as RAM (random access memory), ROM (read-only memory), hard disk drive, or other nonvolatile storage device.

In the embodiment described above, the printer 12 generates printed text data based on the print data appropriate to a transaction. However, the control server 15 may receive the print data from the printer 12, and generate the printed text data based on the received print data. More specifically, the device that generates the printed text data (text data) is not limited to the printer 12.

In the embodiment described above, the printer 12, and tablet terminal 13 configured to function as a host computer, communicate wirelessly. However, communication between the printer 12 and host computer is not limited to wireless communication, and may be configured to communicate by wire using a wired LAN communication standard, USB or serial communication standard other than USB, or wired communication using a parallel communication standard. The host computer is also not limited to a tablet terminal 13 or other slate device, and may be a desktop device, for example.

The function blocks described with reference to the figures may be embodied as desired by a combination of hardware and software, and do not suggest a specific hardware configuration.

It should be recognized that the embodiments described above may be varied in many ways. Such variations are not to be regarded as a departure from the spirit and scope of the invention, and all such modifications as would be obvious to one skilled in the art are intended to be included within the scope of the following claims.

What is claimed is:

1. An information processing device comprising a controller configured to:
acquire text data of information printed on a print medium written as text;
parse the text written in the acquired text data into words;
display the words such that at least some of the words are selectable; and
analyze the text data based on one or more selected words.

2. The information processing device of claim 1, wherein:
the text is arranged in the text data according to a layout in which information is printed on the print medium; and
the controller is configured to display the text parsed into words according to said layout.

3. The information processing device of claim 1, wherein:
the controller is configured to apply a specific style to the displayed words that are candidates for selection.

4. The information processing device of claim 1, wherein:
the controller is configured such that, when one word is selected, the controller enables selection of words that are consecutive to the one word and are on the same line as the one word.

5. The information processing device of claim 1, wherein:
the controller is configured to be connected to a printing device configured to print a receipt; and
the controller is configured to acquire, as the text data, information printed on the receipt by the printing device.

6. The information processing device of claim 1, wherein:
the controller is configured to parse the text written in the text data into words based on space characters representing white space, and delimiter characters including a return character representing a new line.

7. The information processing device of claim 6, wherein:
the text includes (i) predefined special characters, and (ii) regular characters other than the delimiter characters and special characters; and
the controller is configured to parse consecutive special characters not interrupted by a delimiter character, and consecutive regular characters not interrupted by a delimiter character, as one word.

8. A control method of an information processing device, the control method comprising:
acquiring text data of information printed on a print medium written as text;
parsing the text written in the acquired text data into words;
displaying the words such that at least some of the words are selectable; and
analyzing the text data based on one or more selected words.

9. The control method of claim 8, wherein:
the text is arranged in the text data according to a layout in which information is printed on the print medium; and
the text parsed into words is displayed according to said layout.

10. The control method of claim 8, further comprising:
applying a specific style to the displayed words that are candidates for selection.

11. The control method of claim 8, further comprising:
when one word is selected, enabling selection of words that are consecutive to the one word and are on the same line as the one word.

12. The control method of claim 8, wherein:
the information processing device is connected to a printing device capable of printing receipts, and
the control method comprises acquiring, as the text data, information printed on the receipt by the printing device.

13. The control method of claim 8, wherein:
the text written in the text data is parsed into words based on space characters representing white space, and delimiter characters including a return character representing a new line.

14. The control method of claim 13, wherein:
the text includes (i) predefined special characters, and (ii) regular characters other than the delimiter characters and special characters; and
consecutive special characters not interrupted by a delimiter character, and consecutive regular characters not interrupted by a delimiter character, are parsed as one word.

15. A non-transient computer-readable medium storing a control program that is executable by a controller of an information processing device, the control program being programmed to cause the controller to execute steps including:
acquiring text data of information printed on a print medium written as text;
parsing the text written in the acquired text data into words;
displaying the words such that at least some of the words are selectable; and
analyzing the text data based on one or more selected words.
